(19) United States
(12) Patent Application Publication
(10) Pub. No.: US 2024/0284066 A1
(43) Pub. Date: Aug. 22, 2024

(54) PHOTOELECTRIC CONVERSION DEVICE

(71) Applicant: CANON KABUSHIKI KAISHA, Tokyo (JP)

(72) Inventors: TAKASHI FUKUHARA, Tokyo (JP); KAZUO YAMAZAKI, Kanagawa (JP)

(21) Appl. No.: 18/437,602

(22) Filed: Feb. 9, 2024

(30) Foreign Application Priority Data
Feb. 17, 2023 (JP) 2023-023094

(51) Int. Cl. H04N 25/677; H04N 25/633

(52) U.S. Cl. CPC H04N 25/677; H04N 25/633

(57) ABSTRACT

A photoelectric conversion device can execute a first driving for outputting a signal based on a sum of charges generated in photoelectric conversion units and a second driving for outputting a signal based on charges generated in one photoelectric conversion unit. A first operation mode in which a signal is read from a pixel of one row by the first driving and a second operation mode in which a signal is read from a pixel of one row by continuously performing the first driving and the second driving are switchable for each row. An output signal of a first pixel row is corrected based on a first correction value based on an output signal of a second pixel row read in the first operation mode and a second correction value based on an output signal of the second pixel row read in the second operation mode.

### BACKGROUND OF THE INVENTION

### Field of the Invention

The present disclosure relates to a photoelectric conversion device.

### Description of the Related Art

Japanese Patent Application Laid-Open No. 2017-98931 discloses a technique relating to an imaging device capable of performing focus detection by a pupil division method. Japanese Patent Application Laid-Open No. 2017-98931 discloses a method of correcting a black level with respect to a signal for a captured image and a signal for focus detection.

In a photoelectric conversion device capable of black level correction as described in Japanese Patent Application Laid-Open No. 2017-98931, correction of a horizontal dark shading shape may be required in addition to correction of black level offset.

### SUMMARY OF THE INVENTION

It is an object of the present disclosure to provide a photoelectric conversion device capable of appropriately correcting horizontal dark shading.

According to a disclosure of the present specification, there is provided a photoelectric conversion device including: a pixel array in which a plurality of pixels are arranged in a plurality of rows and a plurality of columns, the pixel array including a first pixel row including a first pixel having a plurality of photoelectric conversion units each configured to generate charges based on incident light and a second pixel row including a non-photosensitive pixel configured to output a signal not based on the incident light; a reading unit configured to read a signal from the first pixel and the non-photosensitive pixel; and a first correction unit configured to correct a signal read from the first pixel. The number of the non-photosensitive pixels arranged in the second pixel row is greater than the number of the first pixels arranged in the second pixel row. Reading of a signal from the pixel array to the reading unit includes a first driving for outputting a signal based on a sum of charges generated in each of the plurality of photoelectric conversion units and a second driving for outputting a signal based on charges generated in one of the plurality of photoelectric conversion units. A first operation mode in which a signal is read from a pixel of one row by the first driving and a second operation mode in which a signal is read from a pixel of one row by continuously performing the first driving and the second driving are switchable for each row. The first correction unit generates a first correction value based on an output signal of the second pixel row read in the first operation mode, generates a second correction value based on an output signal of the second pixel row read in the second operation mode, and corrects an output signal of the first pixel row based on the first correction value and the second correction value.

Further features of the present invention will become apparent from the following description of exemplary embodiments with reference to the attached drawings.

### BRIEF DESCRIPTION OF THE DRAWINGS

FIG. 1 is a conceptual diagram for illustrating the relationship between an exit pupil of a photographic lens and an effective pixel.

FIG. 2 is a block diagram for illustrating a photoelectric conversion device according to a first embodiment.

FIG. 3 is a diagram for illustrating a layout of a pixel array according to the first embodiment.

FIG. 4 is a diagram for illustrating the effective pixel and a column reading unit.

FIG. 5 is a diagram for illustrating a dummy pixel.

FIG. 6 is a timing chart for illustrating a first operation mode.

FIG. 7 is a timing chart for illustrating a second operation mode.

FIG. 8A and FIG. 8B are diagrams for illustrating an example of switching the operation mode in the effective pixel row or the OB pixel row and an example of a horizontal dark shading shape, respectively.

FIG. 9A and FIG. 9B are diagrams for illustrating an example of switching the operation mode in the dummy pixel row and an example of the horizontal dark shading shape, respectively.

FIG. 10 is a block diagram of a signal processing circuit.

FIG. 11 is a block diagram of a second correction unit according to the first embodiment.

FIG. 12 is a block diagram of a first correction unit according to the first embodiment.

FIG. 13 is a processing flowchart of the first correction unit according to the first embodiment.

FIG. 14A, FIG. 14B, and FIG. 14C are graphs for illustrating correction effects in the first embodiment.

FIG. 15 is a diagram for illustrating a layout of a pixel array according to a second embodiment.

FIG. 16 is a block diagram of the first correction unit according to the second embodiment.

FIG. 17 is a processing flowchart of the first correction unit according to the second embodiment.

FIG. 18 is a block diagram of the first correction unit according to a third embodiment.

FIG. 19 is a processing flowchart of the first correction unit according to the third embodiment.

FIG. 20A, FIG. 20B, and FIG. 20C are graphs for illustrating correction effects in the third embodiment.

FIG. 21 is a diagram for illustrating a layout of a pixel array according to a fourth embodiment.

FIG. 22 is a block diagram of equipment according to a fifth embodiment.

FIG. 23A and FIG. 23B are block diagrams of equipment according to a sixth embodiment.

### DESCRIPTION OF THE EMBODIMENTS

Preferred embodiments of the present invention will now be described in detail in accordance with the accompanying drawings. In the drawings, the same or corresponding elements are denoted by the same reference numerals, and the description thereof may be omitted or simplified.

In the following first to fourth embodiments, an imaging device will be mainly described as an example of a photoelectric conversion device. However, the photoelectric conversion device of each embodiment is not limited to the imaging device, and can be applied to other devices. Examples of other devices include a ranging device and a photometry device. The ranging device may be, for example, a focus detection device, a distance measuring device using a time-of-flight (TOF), or the like. The photometric device may be a device that measures the amount of light incident on the device.

### First Embodiment

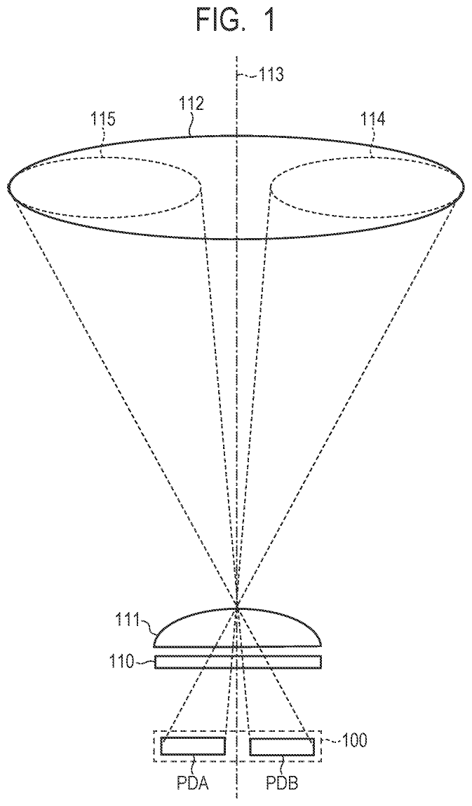

A photoelectric conversion device according to a first embodiment will be described with reference to FIGS. 1 to 14C. A principle of focus detection by a pupil division method performed in the photoelectric conversion device according to the present embodiment will be described with reference to FIG. 1. FIG. 1 is a conceptual diagram for illustrating a relationship between an exit pupil of a photographic lens (not illustrated) and an effective pixel.

An effective pixel 100 (first pixel) includes a photodiode PDA and a photodiode PDB. A color filter 110 and a microlens 111 are placed above the effective pixel 100. Each of the photodiodes PDA and PDB is a photoelectric conversion unit that generates charges according to incident light.

The light incident on the photoelectric conversion device is incident on the effective pixel 100 around an optical axis 113. A light beam passing through a pupil area 114, which is part of an exit pupil 112 of the photographic lens, travels through the microlens 111, and is received by the photodiode PDA. Meanwhile, a light beam passing through a pupil area 115, which is another part of the exit pupil 112 of the photographic lens, travels through the microlens 111, and is received by the photodiode PDB. Thus, the photodiode PDA and the photodiode PDB separately receive light that has passed through different pupil areas 114 and 115 of the exit pupil 112. A phase difference can be detected by comparing a signal that is output from the photodiode PDA with a signal output from the photodiode PDB. The focus can be adjusted with respect to the imaging target by detecting and adjusting the amount of shift in the focal position of the imaging lens placed on the optical axis 113 based on the phase difference thus obtained.

A signal based on the charges generated in the photodiode PDA is defined as an image signal A. A signal based on the charges generated in the photodiode PDB is defined as an image signal B. The image signal A and the image signal B are phase difference signals used for focus detection. A signal obtained by summing the charges generated in each of the photodiodes PDA and PDB is defined as an image signal A+B. The image signal A+B is an image signal constituting a photographed image.

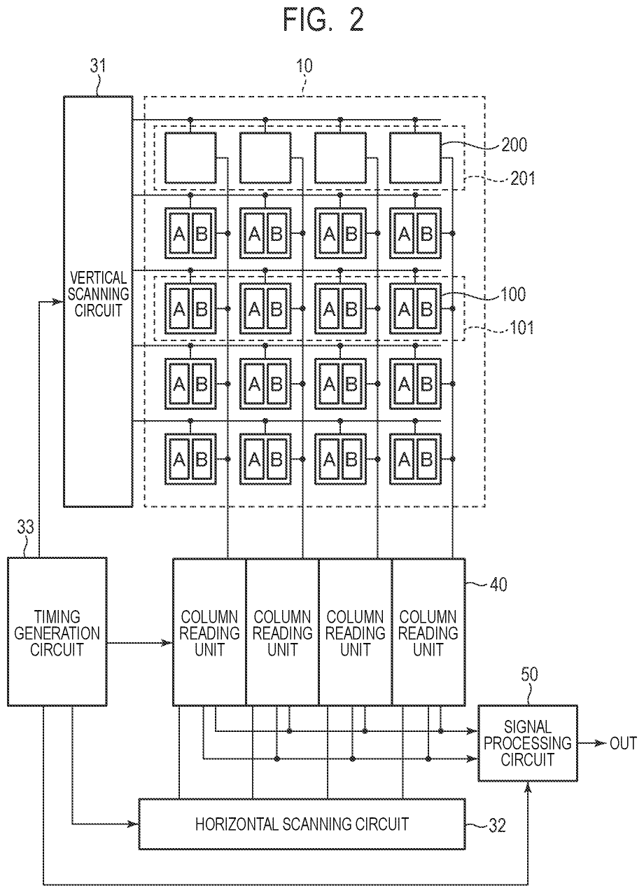

The configuration of the photoelectric conversion device will be described with reference to FIGS. 2 to 5. FIG. 2 is a block diagram for illustrating the photoelectric conversion device according to the present embodiment. As illustrated in FIG. 2, the photoelectric conversion device includes a pixel array 10, a column reading unit 40, a vertical scanning circuit 31, a horizontal scanning circuit 32, a timing generation circuit 33, and a signal processing circuit 50.

The pixel array 10 includes a plurality of pixels arranged in a plurality of rows and a plurality of columns (in a matrix). The pixel array 10 includes an effective pixel row 101 (first pixel row) in which effective pixels 100 including two photodiodes PDA and PDB are arranged, and a non-photosensitive pixel row 201 (second pixel row) in which non-photosensitive pixels 200 having no sensitivity to light are arranged. That is, each of the plurality of pixels may be either the effective pixel 100 or the non-photosensitive pixel 200. Although the arrangement of pixels in four columns and five rows is illustrated in FIG. 2 for simplicity of explanation, a greater number of effective pixels 100 and non-photosensitive pixels 200 may actually be arranged in the pixel array 10. In the present embodiment, the non-photosensitive pixel row 201 is provided with the non-photosensitive pixels 200, and the effective pixels 100 are not provided. However, the present invention is not limited to this example, and the number of effective pixels 100 smaller than that of the non-photosensitive pixels 200 may be included in the non-photosensitive pixel row 201. In the present embodiment, the non-photosensitive pixel row 201 includes the non-photosensitive pixels 200 for each column provided with the effective pixels 100 provided in one effective pixel row 101. That is, all the pixel columns included in one effective pixel row 101 include the first column closest to one end of the photoelectric conversion device and the second column closest to the opposite end. Also in the non-photosensitive pixel row 201, the non-photosensitive pixels 200 are provided from the first column to the second column.

The vertical scanning circuit 31 selects pixels arranged in the pixel array 10 in units of one row, and outputs a driving signal to the pixels in the selected row. A logic circuit such as a shift register or an address decoder can be used for the vertical scanning circuit 31.

The column reading units 40 are arranged corresponding to the respective columns of the pixel array 10. The column reading unit 40 performs analog-to-digital conversion of the signal output from the pixel and holds the signal. The horizontal scanning circuit 32 outputs a horizontal scanning pulse signal to the column reading unit 40 of each column. The logic circuit such as the shift register or the address decoder can be used for the horizontal scanning circuit 32. The column reading unit 40 of each column sequentially outputs the signals held in the signal processing circuit 50 based on the horizontal scanning pulse signals.

The timing generation circuit 33 outputs control signals for controlling the column reading unit 40, the vertical scanning circuit 31, the horizontal scanning circuit 32, and the signal processing circuit 50.

The signal processing circuit 50 performs signal processing such as correction processing on the signal output from the column reading unit 40. The signal processing circuit 50 outputs the processed signal to the outside of the photoelectric conversion device.

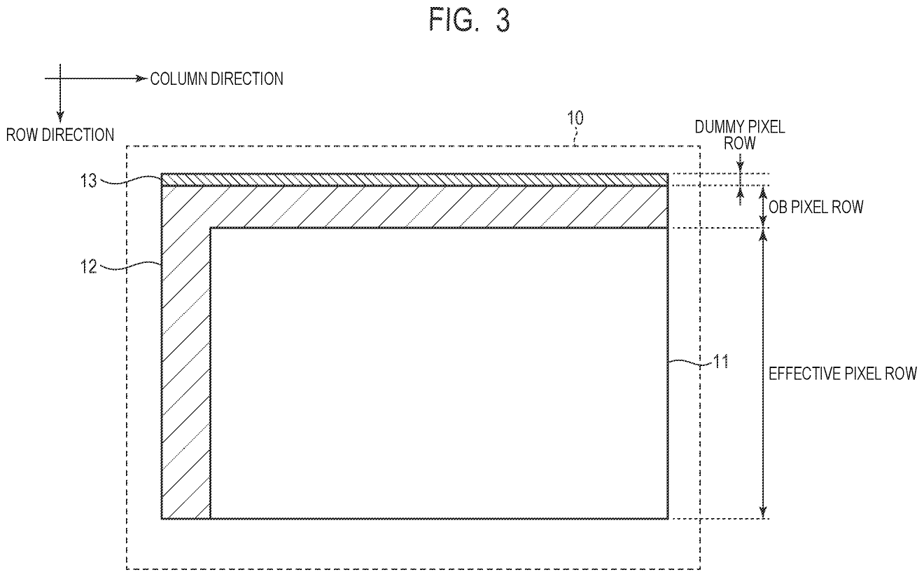

FIG. 3 is a diagram for illustrating a layout of the pixel array 10. The pixel array 10 includes an effective pixel area 11, an optical black (OB) pixel area 12, and a dummy pixel area 13. The effective pixel area 11 is a rectangular area in which effective pixels 100 are arranged, and occupies most of the pixel array 10.

The OB pixel area 12 is an L-shaped area in which the OB pixel (third pixel) is arranged, and is arranged along two sides of the effective pixel area 11. The OB pixel is a pixel having a structure in which the photodiodes PDA and PDB are shielded from light by further arranging an optical light shielding structure in a pixel having a structure similar to that of the effective pixel 100.

The dummy pixel area 13 is a rectangular area in which the dummy pixel (second pixel) is arranged, and is arranged along the upper side of the OB pixel area 12. The dummy pixel is a pixel having a structure in which the photodiodes PDA and PDB are removed from a pixel having a structure similar to that of the OB pixel.

A row in which the dummy pixel is arranged is referred to as a dummy pixel row, and a row in which the OB pixel is arranged is referred to as an OB pixel row. A row in which the effective pixel 100 is mainly arranged is the effective pixel row 101 illustrated in FIG. 2. The non-photosensitive pixel row 201 illustrated in FIG. 2 is the dummy pixel row or the OB pixel row.

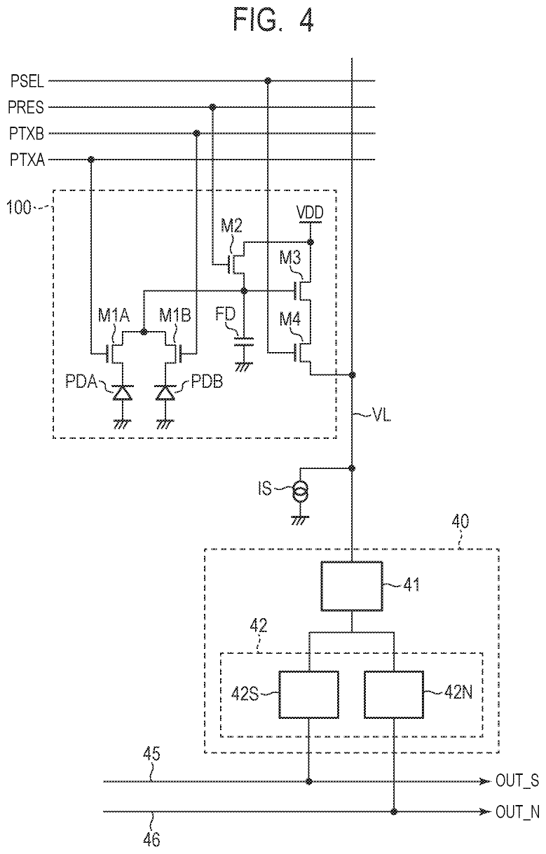

FIG. 4 is a diagram for illustrating the circuit configuration of the effective pixel 100 and the column reading unit 40. For simplicity, FIG. 4 illustrates one effective pixel 100 and the column reading unit 40 corresponding to the effective pixel 100.

The effective pixel 100 includes photodiodes PDA and PDB, transfer transistors M1A and M1B, a reset transistor M2, an amplifying transistor M3, and a selection transistor M4. The effective pixel 100 is connected to the column reading unit 40 via an output line VL to which a current source IS is connected.

Anodes of the photodiodes PDA and PDB are connected to a ground node. A cathode of the photodiode PDA is connected to a source of the transfer transistor M1A and a cathode of the photodiode PDB is connected to a source of the transfer transistor M1B. Drains of the transfer transistors M1A and M1B are connected to a source of the reset transistor M2 and a gate of the amplifying transistor M3. A node to which the drains of the transfer transistors M1A and M1B, the source of the reset transistor M2, and the gate of the amplifying transistor M3 are connected is a floating diffusion FD.

The floating diffusion FD includes a capacitance component and functions as a charge holding portion. The floating diffusion FD performs charge-to-voltage conversion of charges generated by photoelectric conversion in the photodiodes PDA and PDB. The coefficient of charge-to-voltage conversion is determined by the junction capacitance, the gate capacitance, the parasitic capacitance between the wirings, and the like of the diffusion layer and the wirings constituting the floating diffusion FD. In FIG. 4, the capacitance of the floating diffusion FD is equivalently illustrated by the circuit symbol of the capacitive element.

A drain of the reset transistor M2 and a drain of the amplifying transistor M3 are connected to a power supply voltage node to which a voltage VDD is supplied. A source of the amplifying transistor M3 is connected to a drain of the selection transistor M4. A source of the selection transistor M4 is connected to the output line VL.

A control signal PTXA is input to a gate of the transfer transistor M1A and a control signal PTXB is input to a gate of the transfer transistor M1B from the vertical scanning circuit 31 via control line. A control signal PRES is input to a gate of the reset transistor M2 from the vertical scanning circuit 31 via the control line. A control signal PSEL is input to a gate of the selection transistor M4 from the vertical scanning circuit 31 via the control line.

In the present embodiment, each transistor constituting the effective pixel 100 is an N-type MOS transistor. Therefore, when a control signal of a high level (H level) is supplied from the vertical scanning circuit 31, the corresponding transistor is turned on. When a control signal of a low level (L level) is supplied from the vertical scanning circuit 31, the corresponding transistor is turned off. The term “source” or “drain” of the MOS transistor may vary depending on the conductivity type of the transistor or the target function. Some or all of names of a source and a drain used in the present embodiment are sometimes referred to as opposite names.

The photodiodes PDA and PDB receive incident light having passed through the same microlens 111, convert the received light into charges of an amount corresponding to the amount of received light, and accumulate the charges. The transfer transistor M1A is turned on to transfer charges held in the photodiode PDA to the floating diffusion FD. The transfer transistor M1B is turned on to transfer charges held in the photodiode PDB to the floating diffusion FD. The charges transferred from the photodiodes PDA and PDB are held in the capacitance of the floating diffusion FD. As a result, a potential of the floating diffusion FD becomes a potential corresponding to the amount of charges transferred from the photodiodes PDA and PDB by charge-to-voltage conversion by the floating diffusion capacitance.

The selection transistor M4 is turned on to connect the amplifying transistor M3 to the output line VL. The amplifying transistor M3 is configured such that a voltage VDD is supplied to the drain and a bias current is supplied from the current source IS to the source via the selection transistor M4, and constitutes an amplifying unit (source follower circuit) having a gate as an input node. Accordingly, the amplifying transistor M3 outputs a signal based on the potential of the floating diffusion FD to the output line VL via the selection transistor M4. In this sense, the amplifying transistor M3 and the selection transistor M4 are output unit that outputs a signal corresponding to the amount of charges held in the floating diffusion FD.

The reset transistor M2 has a function of resetting the floating diffusion FD by controlling supply of a voltage (voltage VDD) to the floating diffusion FD. By turning on the reset transistor M2, the floating diffusion FD is reset to a voltage corresponding to the voltage VDD.

The column reading unit 40 includes an analog-to-digital conversion unit 41 and a storage unit 42. The output line VL is connected to the analog-to-digital conversion unit 41. The analog-to-digital conversion unit 41 converts an analog signal input through the output line VL into a digital signal. The analog-to-digital conversion unit 41 includes, for example, a comparison circuit and a counter circuit. The comparison circuit compares a ramp signal whose potential changes depending on time with an input signal, and outputs a signal to the counter circuit at a timing when the magnitude relationship between the ramp signal and the input signal is reversed. The counter circuit receives a signal from the comparison circuit and holds a count value at the timing. The count value held by the counter circuit is held as a digital value in the storage unit 42.

The storage unit 42 includes two memories 42S and 42N for holding digital signals. The memory 42S holds the image signal A, the image signal B, or the image signal A+B. The memory 42N holds a noise signal (signal N) based on the reset state of the floating diffusion. The digital signal held in the memory 42S is output to the signal processing circuit 50 via the digital signal output line 45 (OUT_S). The digital signal held in the memory 42N is output to the signal processing circuit 50 via the digital signal output line 46 (OUT_N).

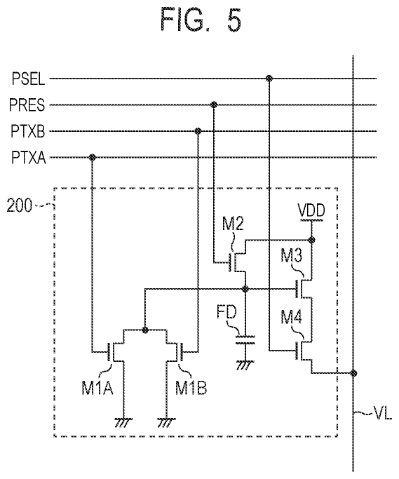

FIG. 5 is a diagram for illustrating a dummy pixel as an example of the non-photosensitive pixel 200. The difference between the dummy pixel and the effective pixel 100 is that the photodiodes PDA and PDB are not provided, and the sources of the transfer transistors M1A and M1B are connected to the ground node. Since the other configurations are the same as those of the effective pixel 100, description thereof will be omitted. Also in the dummy pixel, the signal reading operation similar to that of the effective pixel 100 is performed, whereby the signal not based on the incident light can be read. Although the non-photosensitive pixel 200 does not have a photodiode, the non-photosensitive pixel 200 can output a signal indicating noise due to dark current leakage or the like generated in the floating diffusion FD and the reset transistor M2. The dark current leakage affects the horizontal dark shading described later.

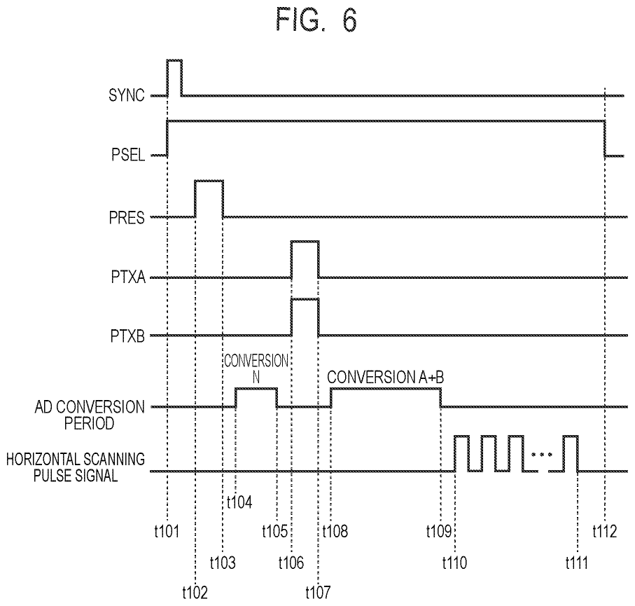

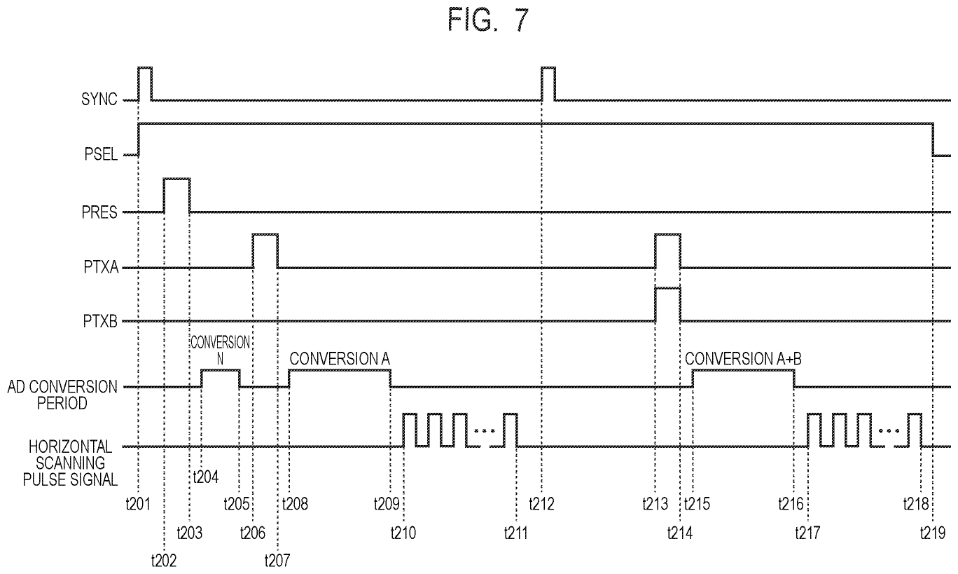

Two kinds of operation modes for reading signals for each row from the pixels of the pixel array 10 will be described with reference to FIGS. 6 and 7. FIG. 6 is a timing chart for illustrating a first operation mode, and FIG. 7 is a timing chart for illustrating a second operation mode. FIGS. 6 and 7 illustrate a horizontal synchronization signal SYNC, control signals PSEL, PRES, PTXA, and PTXB, an analog-to-digital (AD) conversion period, and a horizontal scanning pulse signal. The horizontal synchronization signal SYNC is a signal indicating a start timing of an operation of reading a signal from a pixel of one row. The “AD conversion period” indicates a period during which analog-to-digital conversion is performed in the analog-to-digital conversion unit 41. The “horizontal scanning pulse signal” indicates a timing at which signals are sequentially transferred from the column reading unit 40 of each column to the signal processing circuit 50. In the case where the operations performed between the case where the pixel to be read is the effective pixel 100 and the case where the pixel to be read is the non-photosensitive pixel 200 are different, the cases may be separately described.

The first operation mode will be described with reference to FIG. 6. The first operation mode includes an operation of reading the signal N and an operation of reading the image signal A+B (first driving). That is, in the first operation mode, the image signals constituting the captured image are read, and the phase difference signal for focus detection is not read.

At time t101, the horizontal synchronization signal SYNC becomes the H level and the control signal PSEL of the selected row becomes the H level. Thus, the selection transistor M4 of the selected row is turned on, and the pixel of the selected row is connected to the output line VL.

At time t102, the control signal PRES becomes the H level. Accordingly, the reset transistor M2 is turned on, and the potential of the floating diffusion FD becomes the reset level.

At time t103, the control signal PRES becomes the L level. Thereby, the reset transistor M2 is turned off, and the reset of the floating diffusion FD is canceled. Since the selection transistor M4 remains in the ON state, an output signal corresponding to the gate potential of the amplifying transistor M3 when the reset of the floating diffusion FD is canceled is output to the output line VL. A pixel signal output from the pixel at time t103, that is, a signal based on the reset level of the floating diffusion FD is the signal N.

During a period from time t104 to time t105, the signal N output to the output line VL is converted into a digital signal by the analog-to-digital conversion unit 41 of the column reading unit 40. The digital signal output from the analog-to-digital conversion unit 41 is held in the memory 42N of the storage unit 42. An operation of converting the signal N into a digital signal during a period from time t104 to time t105 is referred to as a conversion N.

At time t106, the control signals PTXA and PTXB become the H level. Thereby, the transfer transistors M1A and M1B are turned on. When the pixel is the effective pixel 100, charges accumulated in the photodiodes PDA and PDB are transferred to the floating diffusion FD. When the pixel is the non-photosensitive pixel 200, charges existing at the nodes of the sources of the transfer transistors M1A and M1B are transferred to the floating diffusion FD. The image signal A+B, which is a pixel signal corresponding to the combined charge, is output to the output line VL.

At time t107, the control signals PTXA and PTXB become the L level. Thereby, the transfer transistors M1A and M1B are turned off. Even after the transfer transistors M1A and M1B are turned off, the image signal A+B is continuously output to the output line VL.

During a period from time t108 to time t109, the image signal A+B output to the output line VL is converted into a digital signal by the analog-to-digital conversion unit 41 of the column reading unit 40. The digital signal output from the analog-to-digital conversion unit 41 is held in the memory 42S of the storage unit 42. An operation of converting the image signal A+B into a digital signal during a period from time t108 to time t109 is referred to as a conversion A+B.

During a period from the time t110 to the time t111, the horizontal scanning pulse signal is output from the horizontal scanning circuit 32 to the column reading unit 40, and the image signal A+B and the signal N, which are digital signals held in the memories 42S and 42N of the respective columns, are sequentially output. The image signal A+B is output from the memory 42S to the signal processing circuit 50 via the digital signal output line 45 (OUT_S). The signal N is output from the memory 42N to the signal processing circuit 50 via the digital signal output line 46 (OUT_N). By repeating such horizontal scanning from the first column to the last column, the image signal A+B and the signal N of one row are read in the first operation mode.

At time t112, the control signal PSEL of the selected row becomes the L level. Thus, the selection transistor M4 of the selected row is turned off, and the pixel of the selected row is not connected to the output line VL.

By the above operation, the signal N and the image signal A+B are read in the first operation mode. In other words, in the first operation mode, the image signals constituting the captured image are read and the phase difference signal for focus detection is not read. In the signal processing circuit 50, processing of subtracting the signal N from the image signal A+B is performed, thereby removing fixed pattern noise.

The second operation mode will be described with reference to FIG. 7. The second operation mode includes the operation of reading the signal N, the operation of reading the image signal A (second driving), and the operation of reading the image signal A+B (first driving). In other words, in the second operation mode, the image signal constituting the captured image and the phase difference signal for focus detection are read. Although FIG. 7 illustrates an example in which the image signal A of the two phase difference signals is read, the image signal B may be read instead of the image signal A.

Since the operation from the time t201 to the time t205 is the same as the operation from the time t101 to the time t105 in FIG. 6, the description thereof will be omitted.

At time t206, the control signal PTXA becomes the H level. Thereby, the transfer transistor M1A is turned on. When the pixel is the effective pixel 100, charges accumulated in the photodiode PDA are transferred to the floating diffusion FD. The image signal A, which is a pixel signal corresponding to the amount of charges accumulated in the photodiode PDA, is output to the output line VL. When the pixel is the non-photosensitive pixel 200, charges existing at the node of the source of the transfer transistor M1A are transferred to the floating diffusion FD. The image signal A, which is a pixel signal corresponding to the amount of charges existing in the floating diffusion FD after transfer, is output to the output line VL.

At time t207, the control signal PTXA becomes the L level. Thereby, the transfer transistor M1A is turned off. Even after the transfer transistor M1A is turned off, the image signal A is continuously output to the output line VL.

During a period from time t208 to time t209, the image signal A output to the output line VL is converted into a digital signal by the analog-to-digital conversion unit 41 of the column reading unit 40. The digital signal output from the analog-to-digital conversion unit 41 is held in the memory 42S of the storage unit 42. An operation of converting the image signal A into a digital signal during a period from time t208 to time t209 is referred to as a conversion A.

During a period from the time t210 to the time t211, the horizontal scanning pulse signal is output from the horizontal scanning circuit 32 to the column reading unit 40, and the image signal A and the signal N, which are digital signals held in the memories 42S and 42N of the respective columns, are sequentially output.

At time t212, the horizontal synchronization signal SYNC becomes the H level. During the period from the time t212 to the time t213, since the control signal PRES remains at the L level, the floating diffusion FD is not reset. When the pixel is the effective pixel 100, the charges generated by the photodiode PDA is held in the floating diffusion FD. When the pixel is the non-photosensitive pixel 200, charges transferred from the node of the source of the transfer transistor M1A are held in the floating diffusion FD.

At time t213, the control signals PTXA and PTXB become the H level. Thereby, the transfer transistors M1A and M1B are turned on. When the pixel is the effective pixel 100, charges accumulated in the photodiode PDB are transferred to the floating diffusion FD. When the pixel is the non-photosensitive pixel 200, charges existing at the node of the source of the transfer transistor M1B are transferred to the floating diffusion FD. The image signal A+B, which is a pixel signal corresponding to the combined charge, is output to the output line VL.

At time t214, the control signals PTXA and PTXB become the L level. Thereby, the transfer transistors M1A and M1B are turned off. Even after the transfer transistors M1A and M1B are turned off, the image signal A+B is continuously output to the output line VL.

During a period from time t215 to time t216, the image signal A+B output to the output line VL is converted into a digital signal by the analog-to-digital conversion unit 41 of the column reading unit 40. The digital signal output from the analog-to-digital conversion unit 41 is held in the memory 42S of the storage unit 42.

During a period from the time t217 to the time t218, the horizontal scanning pulse signal is output from the horizontal scanning circuit 32 to the column reading unit 40, and the image signal A+B and the signal N, which are digital signals held in the memories 42S and 42N of the respective columns, are sequentially output.

At time t219, the control signal PSEL of the selected row becomes the L level. Thus, the selection transistor M4 of the selected row is turned off, and the pixel of the selected row is not connected to the output line VL.

By the above operation, the signal N, the image signal A, and the image signal A+B are read in the second operation mode. In other words, in the second operation mode, the image signal constituting the captured image and the phase difference signal for focus detection are read. In the signal processing circuit 50, processing of subtracting the signal N from each of the image signal A and the image signal A+B is performed, thereby removing fixed pattern noise.

As described above, the photoelectric conversion device of the present embodiment can execute the first driving for outputting the signal A+B and the second driving for outputting the signal A. In the first operation mode, the first driving is performed, and in the second operation mode, the first driving is continuously performed after the second driving is performed. The image signal B used for phase difference detection is obtained, for example, by subtracting the image signal A from the image signal A+B in the signal processing circuit 50 or the like. The timing generation circuit 33 can appropriately switch the reading operation mode for each row by appropriately switching the output mode of the control signal for each row. That is, in the photoelectric conversion device of the present embodiment, the rows for acquiring the phase difference information can be switched as necessary.

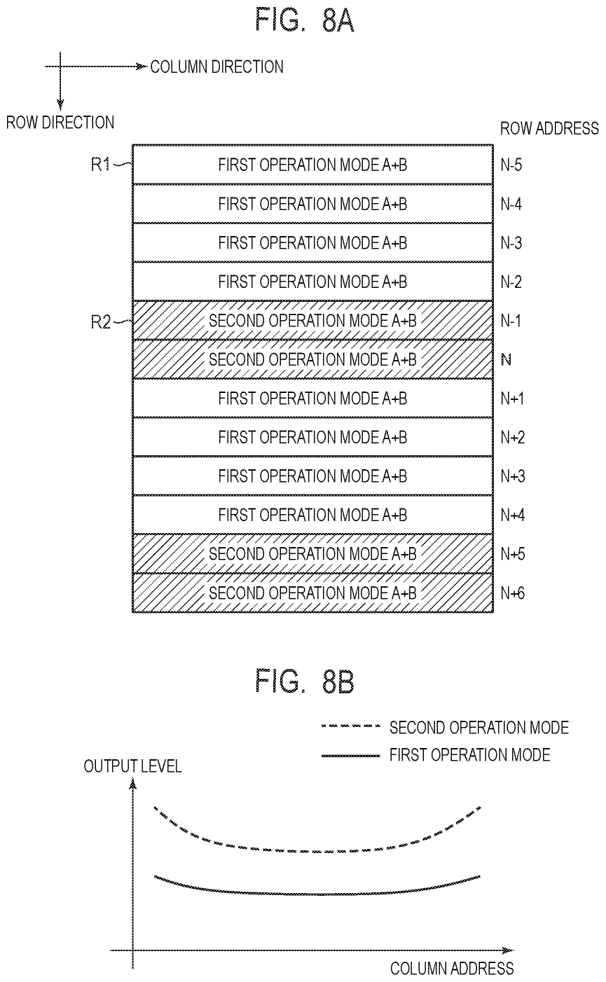

The differences in the horizontal dark shading shape between the first operation mode and the second operation mode will be described. The horizontal dark shading shape is a distribution of output signal levels in a row in the absence of incident light. FIGS. 8A and 8B are diagrams for illustrating an example of switching the operation mode in the effective pixel row or the OB pixel row and an example of a horizontal dark shading shape.

FIG. 8A illustrates an example of switching between the first operation mode and the second operation mode when the image signal A+B is output from the effective pixel row illustrated in FIG. 3. In the twelve rows between the (N−5)-th row and the (N+6)-th row, eight rows from the (N−5)-th row to the (N−2)-th row and from the (N+1)-th row to the (N+4)-th row, are the normal rows R1 in which reading is performed in the first operation mode. Four rows of the (N−1)-th row, the N-th row, the (N+5)-th row, and the (N+6)-th row are the focus detection rows R2 in which reading is performed in the second operation mode. In FIG. 8A, the focus detection row R2 is hatched. In this way, in a plurality of rows of the effective pixel area 11, the normal row R1 in which reading is performed in the first operation mode and the focus detection row R2 in which reading is performed in the second operation mode are repeated.

FIG. 8B is a graph for illustrating an example of a horizontal dark shading shape in each of the first operation mode and the second operation mode. The horizontal axis of the graph indicates the column address of the pixel array 10, and the vertical axis indicates the output level of the signal output from the pixel. As illustrated in the timing charts of FIGS. 6 and 7, the length of the period from the conversion N to the conversion A+B in the first operation mode is different from the length of the period from the conversion N to the conversion A+B in the second operation mode. Therefore, the difference in the accumulation time of the dark current leakage component mentioned in the description of FIG. 5 appears as the difference in the horizontal dark shading shape of an image output A+B between the operation modes. Further, in the effective pixel row, the difference in the dark current component caused by the arrangement of the photodiodes PDA and PDB in the pixels is also superimposed on the difference in the horizontal dark shading shape. Although FIGS. 8A and 8B illustrate examples of effective pixel rows, the same applies to the OB pixel rows.

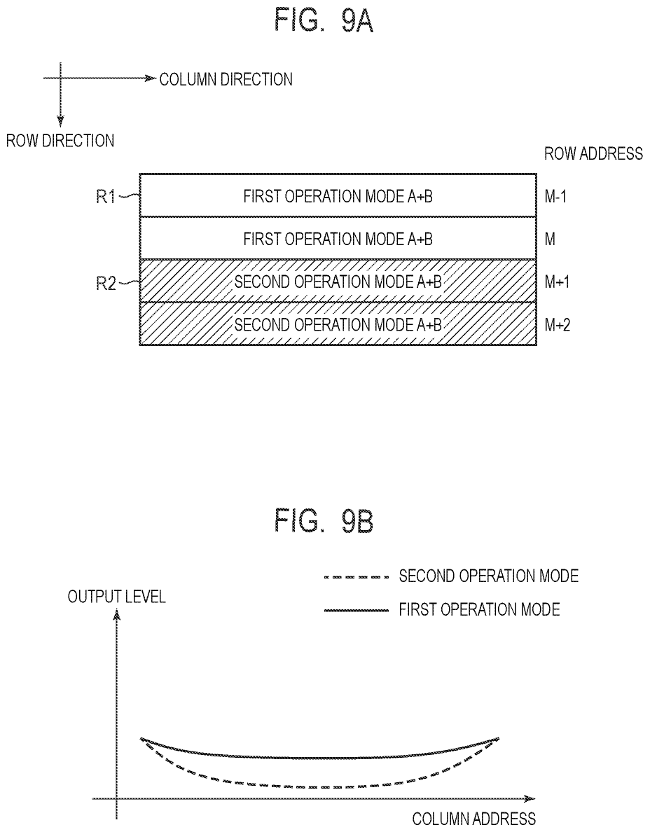

The difference in the horizontal dark shading shape between the first operation mode and the second operation mode with respect to the dummy pixel row will be described. FIGS. 9A and 9B are diagrams for illustrating an example of switching the operation mode in the dummy pixel row and an example of the horizontal dark shading shape.

FIG. 9A illustrates an example of switching between the first operation mode and the second operation mode when the image signal A+B is output from the dummy pixel row illustrated in FIG. 3. In the four rows from the (M−1)-th row to the (M+2)-th row, the (M−1)-th row and the M-th row are the normal rows R1 in which reading is performed in the first operation mode. The (M+1)-th row and the (M+2)-th row are the focus detection rows R2 in which reading is performed in the second operation mode. As described above, the normal row R1 and the focus detection row R2 are also included in a plurality of rows of the dummy pixel area 13.

FIG. 9B is a graph for illustrating an example of the horizontal dark shading shape in each of the first operation mode and the second operation mode. Since no photodiode is included in the dummy pixel, a dark current component due to the photodiode does not occur. Thus, the horizontal dark shading shape of FIG. 9B may be different from the horizontal dark shading shape of FIG. 8B. As illustrated in FIG. 9B, the offset difference of the output level is small between the two operation modes, and the shape difference of the horizontal dark shading mainly appears. Such a characteristic difference for each type of pixel can be used for correction of shading shape difference.

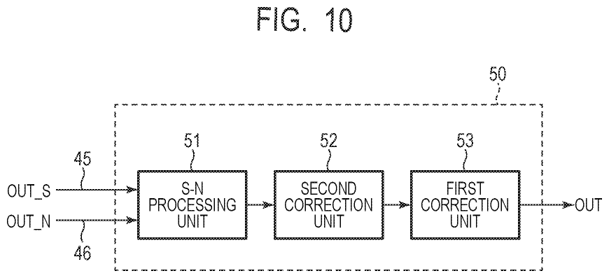

The signal processing performed in the signal processing circuit 50 will be described with reference to FIG. 10. FIG. 10 is a block diagram for illustrating the signal processing circuit 50. As illustrated in FIG. 10, the signal processing circuit 50 includes an S-N processing unit 51, a second correction unit 52, and a first correction unit 53.

The image signal A+B, the image signal A, or the image signal B is input to the S-N processing unit 51 through the digital signal output line 45. In addition, the signal N is input to the S-N processing unit 51 through the digital signal output line 46. The S-N processing unit 51 subtracts the signal N from the image signal A+B, the image signal A, or the image signal B. This reduces fixed pattern noise. The image signal A+B, the image signal A, or the image signal B after the subtraction processing of the signal N is input to the second correction unit 52. The second correction unit 52 corrects the offset difference between the operation modes. The corrected signal is input to the first correction unit 53. The first correction unit 53 is configured to correct the shading shape difference between the operation modes. By the above processing, the offset difference and shading shape difference between the operation modes are corrected. The corrected signal is output to the outside of the photoelectric conversion device. Hereinafter, more detailed configurations of the second correction unit 52 and the first correction unit 53 and correction processing performed by the second correction unit 52 and the first correction unit 53 will be described in order.

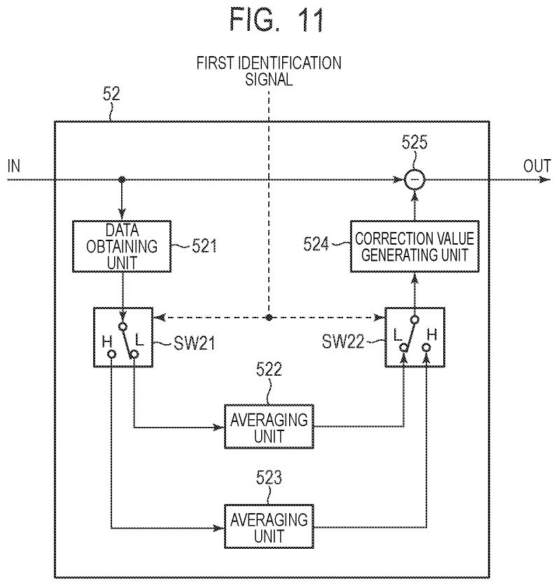

The second correction unit 52 will be described with reference to FIG. 11. The second correction unit 52 performs correction processing to bring a black level close to the reference level using an output signal from the OB pixel in the OB pixel area 12. FIG. 11 is a block diagram of the second correction unit 52 in the present embodiment. The second correction unit 52 includes a data obtaining unit 521, averaging units 522 and 523, a correction value generating unit 524, a subtraction unit 525, and switches SW21 and SW22.

The data obtaining unit 521 selects and obtains the output signal from the OB pixel in the OB pixel area 12 among the input signals to the second correction unit 52. The pixel signal obtained by the data obtaining unit 521 is output to the switch SW21.

The switch SW21 switches the terminal for outputting the pixel signal according to the level of a first identification signal input from the timing generation circuit 33. The first identification signal is assumed to be at the L level when the pixel signal input to the second correction unit 52 is read from the normal row R1 in the first operation mode. The first identification signal is assumed to be at the H level when the pixel signal input to the second correction unit 52 is read from the focus detection row R2 in the second operation mode. The switch SW21 outputs a pixel signal to the averaging unit 522 when the first identification signal is at the L level, and outputs a pixel signal to the averaging unit 523 when the first identification signal is at the H level. Note that “L” and “H” described in the circuit symbols of the switches represent output terminals corresponding to the level of the input identification signal. The switch SW22 performs the same switching operation in response to the first identification signal.

The averaging units 522 and 523 perform averaging processing on the input pixel signals to calculate an average black level. The averaging unit 522 performs averaging processing on the signals read from the normal row R1, and the averaging unit 523 performs averaging processing on the signals read from the focus detection row R2. The average black level calculated by the averaging units 522 and 523 is input to the correction value generating unit 524 via the switch SW22. When the first identification signal is at the L level, the switch SW22 outputs the signal input from the averaging unit 522 to the correction value generating unit 524. When the first identification signal is at the H level, the switch SW22 outputs the signal input from the averaging unit 523 to the correction value generating unit 524.

Based on the difference between the average black level and a predetermined reference level, the correction value generating unit 524 generates a correction value so as to match the average black level to the reference level. The correction value is used for correction processing of a signal read from an effective pixel row.

The subtraction unit 525 performs correction processing to bring the black level close to the reference level by subtracting the correction value generated by the correction value generating unit 524 from the pixel signal output from the effective pixel 100 positioned in the effective pixel row. The pixel signal output from the normal row R1 is subjected to processing of subtracting a correction value (fourth correction value) based on the average black level calculated by the averaging unit 522 for the normal row R1. On the other hand, the pixel signal output from the focus detection row R2 is subjected to processing of subtracting a correction value (fifth correction value) based on the average black level calculated by the averaging unit 523 for the focus detection row R2.

In this way, the second correction unit 52 can appropriately change the correction value according to the operation mode to correct the offset difference.

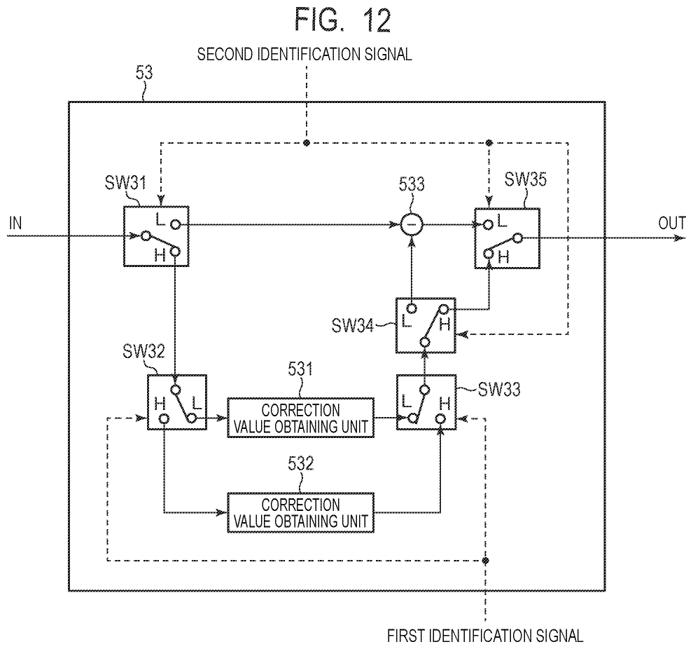

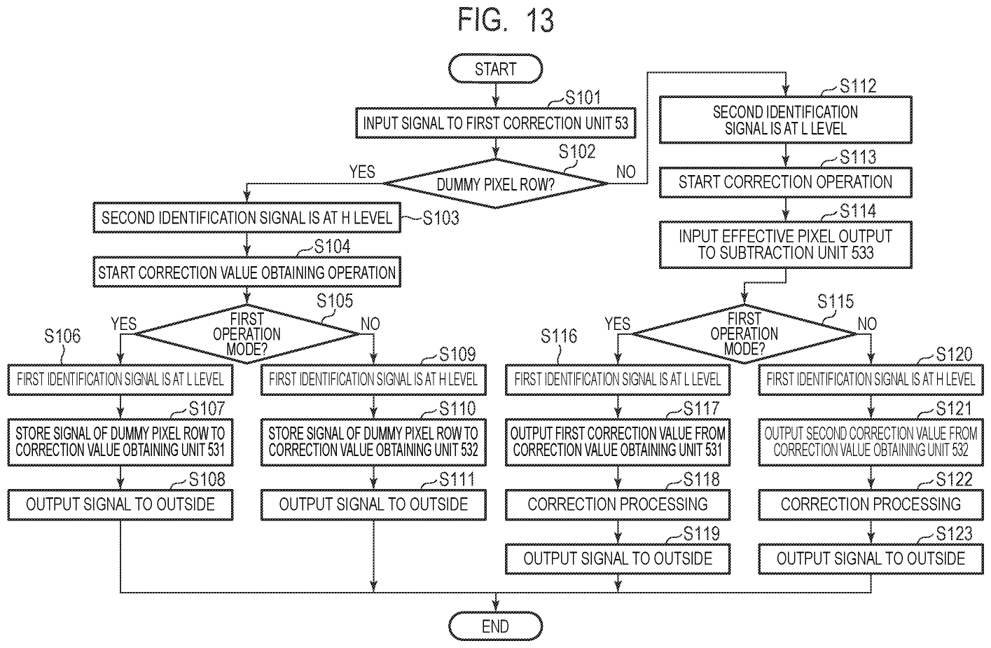

The first correction unit 53 will be described with reference to FIGS. 12 and 13. The first correction unit 53 performs correction processing for reducing the horizontal dark shading shape difference of the black level by using the signals from the pixels in the dummy pixel row as correction values. FIG. 12 is a block diagram of the first correction unit 53 in the present embodiment. The first correction unit 53 includes correction value obtaining units 531 and 532, a subtraction unit 533, and switches SW31, SW32, SW33, SW34, and SW35. The switches SW32 and SW33 are switched based on the level of the first identification signal. The switches SW31, SW34, and SW35 are switched based on the level of a second identification signal input from the timing generation circuit 33. The second identification signal is assumed to be at the H level when the pixel signal input to the first correction unit 53 is read from the dummy pixel row. Further, the second identification signal is assumed to be at the L level when the pixel signal input to the first correction unit 53 is read from a row other than the dummy pixel row.

The switch SW31 switches a terminal for outputting a signal input from the second correction unit 52 according to the level of the first identification signal. The switch SW31 outputs a signal to the subtraction unit 533 when the second identification signal is at the L level, and outputs a signal to the switch SW32 when the second identification signal is at the H level.

The switch SW32 outputs a signal to the correction value obtaining unit 531 when the first identification signal is at the L level, and outputs a signal to the correction value obtaining unit 532 when the first identification signal is at the H level. The correction value obtaining unit 531 holds a signal read from the normal row R1 of the dummy pixel rows in the first operation mode as a first correction value. The correction value obtaining unit 532 holds a signal read from the focus detection row R2 of the dummy pixel row in the second operation mode as a second correction value. These correction values may have different values for each column address of the pixel array 10. Each of the correction value obtaining units 531 and 532 may have a line memory for holding these correction values.

The switch SW33 outputs an output signal from the correction value obtaining unit 531 to the switch SW34 when the first identification signal is at the L level, and outputs an output signal from the correction value obtaining unit 532 to the switch SW34 when the first identification signal is at the H level. The switch SW34 outputs an output signal from the switch SW33 to the subtraction unit 533 when the second identification signal is at the L level, and outputs an output signal from the switch SW33 to the switch SW35 when the second identification signal is at the H level.

The subtraction unit 533 subtracts the signal output from the switch SW34 from the signal output from the switch SW31 and outputs the subtracted signal to the switch SW35. That is, the subtraction unit 533 performs processing of correcting the pixel signal output from the effective pixel row using the correction value held in the correction value obtaining unit 531 or 532.

The switch SW35 outputs a signal to the outside from the subtraction unit 533 when the second identification signal is at the L level, and outputs a signal to the outside from the switch SW34 when the second identification signal is at the H level.

A correction processing procedure of the first correction unit 53 according to the present embodiment will be described with reference to FIG. 13. FIG. 13 is a processing flowchart of the first correction unit 53 according to the present embodiment. FIG. 13 illustrates processing from the time when a signal read from one pixel row is input to the first correction unit 53 to the time when a signal is output.

First, a signal of one pixel row corrected by the second correction unit 52 is input to the first correction unit 53 (step S101). When the pixel row is the dummy pixel row (YES in step S102), the second identification signal output from the timing generation circuit 33 is at the H level (step S103). In this case, the switches SW31, SW34, and SW35 are switched to the terminals denoted by “H” illustrated in FIG. 12. At this time, the first correction unit 53 starts a correction value obtaining operation based on the input signal (step S104).

On the other hand, when the pixel row is not the dummy pixel row (NO in step S102), the second identification signal output from the timing generation circuit 33 is at the L level (step S112). In this case, the switches SW31, SW34, and SW35 are switched to the terminals denoted by “L” illustrated in FIG. 12. At this time, the first correction unit 53 starts a correction operation of the input signal (step S113).

The correction value obtaining operation started from step S104 and the correction operation started from step S113 will be described in order. The correction value obtaining operation started from step S104 will be described.

The signal of the dummy pixel row input to the first correction unit 53 is read from the pixel array 10 in the first operation mode or the second operation mode. When the signal of the dummy pixel row is read in the first operation mode (YES in step S105), the first identification signal output from the timing generation circuit 33 is at the L level (step S106). In this case, the switches SW32 and SW33 are switched to the terminal denoted by “L” illustrated in FIG. 12. The signal of the dummy pixel row read in the first operation mode is input to the correction value obtaining unit 531 via the switches SW31 and SW32.

The correction value obtaining unit 531 stores the input signal of the dummy pixel row in the line memory for each pixel (step S107). The signal held in the line memory is used as the first correction value. The correction value obtaining unit 531 may include an addition averaging unit. When there are a plurality of dummy pixel rows read in the first operation mode, the addition averaging unit may perform averaging processing of the correction values.

The input signal of the dummy pixel row is held in the correction value obtaining unit 531, and is output to the outside of the first correction unit 53 via the switches SW33, SW34, and SW35 in this order (step S108).

On the other hand, when the signal of the dummy pixel row is read in the second operation mode (NO in step S105), the first identification signal output from the timing generation circuit 33 is at the H level (step S109). In this case, the switches SW32 and SW33 are switched to the terminals denoted by “H” illustrated in FIG. 12. The signal of the dummy pixel row read in the second operation mode is input to the correction value obtaining unit 532 via the switches SW31 and SW32.

Similarly to the correction value obtaining unit 531, the correction value obtaining unit 532 stores the input signal of the dummy pixel row in the line memory for each pixel (step S110). The signal held in the line memory is used as a second correction value. The input signal of the dummy pixel row is held in the correction value obtaining unit 532, and is output to the outside of the first correction unit 53 via the switches SW33, SW34, and SW35 in this order (step S111).

As described above, the correction value obtaining unit 531 holds an output signal from the dummy pixel row as the first correction value and the correction value obtaining unit 532 holds an output signal from the dummy pixel row as the second correction value according to the operation mode at the time of reading the dummy pixel rows. These correction values are used when a signal read from the effective pixel row is corrected for each pixel.

The correction operation started from step S113 will be described. It is assumed that the first correction value and the second correction value have already been held in the correction value obtaining units 531 and 532 by the above-described processing.

A signal input at the time of the correction operation is a signal from other than the dummy pixel row. In the following description, it is assumed that the input signal is a signal output from the effective pixel row. Further, it is assumed that the correction processing is performed on the image signal A+B. The signal of the effective pixel row is input to the subtraction unit 533 via the switch SW31 (step S114).

The subtraction unit 533 performs processing for correcting the horizontal dark shading shape by subtracting one of the first correction value and the second correction value from the signal output from the effective pixel row. A method of switching the correction value will be described.

The signal of the effective pixel row input to the first correction unit 53 is read from the pixel array 10 in the first operation mode or the second operation mode. When the signal of the effective pixel row is read in the first operation mode (YES in step S115), the first identification signal output from the timing generation circuit 33 is at the L level (step S116). In this case, the switch SW33 is switched to a terminal denoted by “L” illustrated in FIG. 12. Thereby, the first correction value held in the correction value obtaining unit 531 is output to the subtraction unit 533 via the switches SW33 and SW34 (step S117). The subtraction unit 533 corrects the horizontal dark shading shape by subtracting the first correction value from the signal of the effective pixel row (step S118). The signal corrected by the subtraction unit 533 is output to the outside of the first correction unit 53 via the switch SW35 (step S119).

On the other hand, when the signal of the effective pixel row is read in the second operation mode (NO in step S115), the first identification signal output from the timing generation circuit 33 is at the H level (step S120). In this case, the switch SW33 is switched to a terminal denoted by “H” illustrated in FIG. 12. Thereby, the second correction value held in the correction value obtaining unit 532 is output to the subtraction unit 533 via the switches SW33 and SW34 (step S121). The subtraction unit 533 corrects the horizontal dark shading shape by subtracting the second correction value from the signal of the effective pixel row (step S122). The signal corrected by the subtraction unit 533 is output to the outside of the first correction unit 53 via the switch SW35 (step S123).

In this way, the subtraction unit 533 performs correction using a correction value that varies depending on the operation mode when the signal from the effective pixel row is read. This makes it possible to appropriately correct the difference between the horizontal dark shading shapes.

In the first correction unit 53 of the present embodiment, correction similar to that of the effective pixel row can be performed for the OB pixel row. However, the first correction unit 53 may be configured such that the output signal of the OB pixel row is output to the outside without being corrected by appropriately providing a switch for switching the path through which the signal passes.

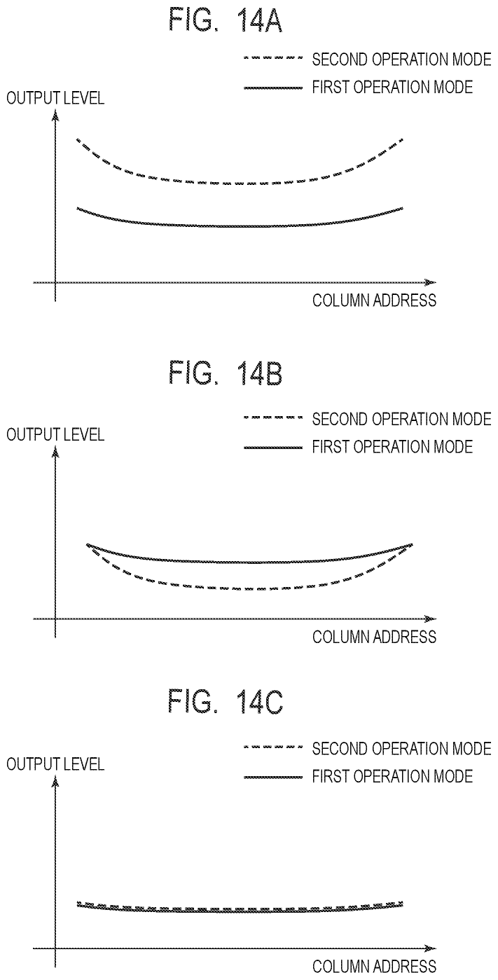

FIGS. 14A, 14B, and 14C are graphs for illustrating the effect of correction in the signal processing circuit 50. Since the vertical axis and the horizontal axis of the graph are the same as those illustrated in FIG. 8B, their description is omitted.

FIG. 14A is a graph for illustrating the shape of the horizontal dark shading before correction. As described above, in the first operation mode and the second operation mode, there is a difference in both the offset and the shape of the horizontal dark shading.

FIG. 14B is a graph for illustrating the shape of horizontal dark shading for each operation mode corrected by the second correction unit 52. The offset component difference is reduced by subtracting the correction value corresponding to the dark current component calculated by the averaging units 522 and 523 of the second correction unit 52.

FIG. 14C is a graph for illustrating the shape of the horizontal dark shading for each operation mode corrected by the first correction unit 53. By subtracting the correction values calculated by the correction value obtaining units 531 and 532 of the first correction unit 53, a horizontal dark shading shape substantially uniform with respect to the column address can be obtained in both the first operation mode and the second operation mode. Thus, since the horizontal dark shading shapes of the first operation mode and the second operation mode are sufficiently close to each other, it is possible to reduce a signal level difference in an image that may occur at the boundary between the normal line and the focus detection line.

As described above, according to the present embodiment, a photoelectric conversion device capable of appropriately correcting horizontal dark shading is provided.

In the present embodiment, the output signal from the dummy pixel row is used for calculating the correction value in the first correction unit 53, but the output signal from the OB pixel row may be used for similar correction processing. For example, in an environment in which the dark current component is sufficiently small, such as in a low temperature environment, the output signal from the OB pixel row can be substituted for the output signal from the dummy pixel row. Further, although the processing performed in the subtraction unit 533 is subtraction, correction may be performed by another calculation processing. For example, depending on the horizontal dark shading shape, the subtraction performed in the subtraction unit 533 may be replaced with addition.

### Second Embodiment

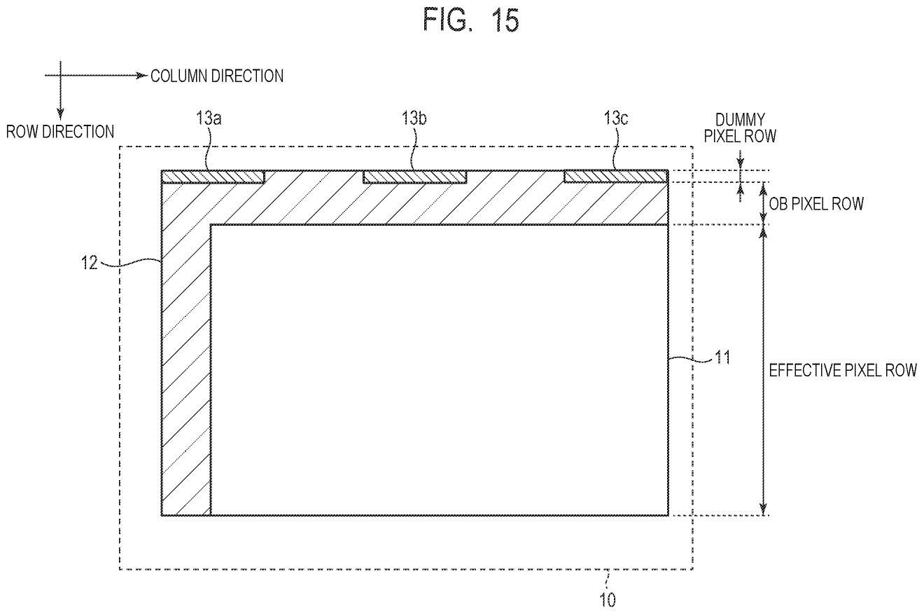

A photoelectric conversion device according to a second embodiment will be described with reference to FIGS. 15 to 17. In the present embodiment, a configuration example in which dummy pixel areas are intermittently arranged in the same row and a method of calculating a correction value in this case will be described. The description of elements common to those of the first embodiment may be omitted or simplified as appropriate.

FIG. 15 is a diagram for illustrating a layout of the pixel array 10 in the present embodiment. In the present embodiment, in the pixel array 10, dummy pixel areas 13a, 13b, and 13c are arranged instead of the dummy pixel area 13 in FIG. 3. As illustrated in FIG. 15, a plurality of dummy pixel areas 13a, 13b, and 13c are intermittently arranged in the same row. The OB pixel area 12 is arranged between the dummy pixel area 13a and the dummy pixel area 13b and between the dummy pixel area 13b and the dummy pixel area 13c. Thus, since the range of the OB pixel area 12 is enlarged, the accuracy of the correction processing (OB clamp processing) of the output signal of the effective pixel 100 using the output signal of the OB pixel can be improved. In the present embodiment, a row including the dummy pixel areas 13a, 13b, and 13c arranged intermittently is referred to as the dummy pixel row.

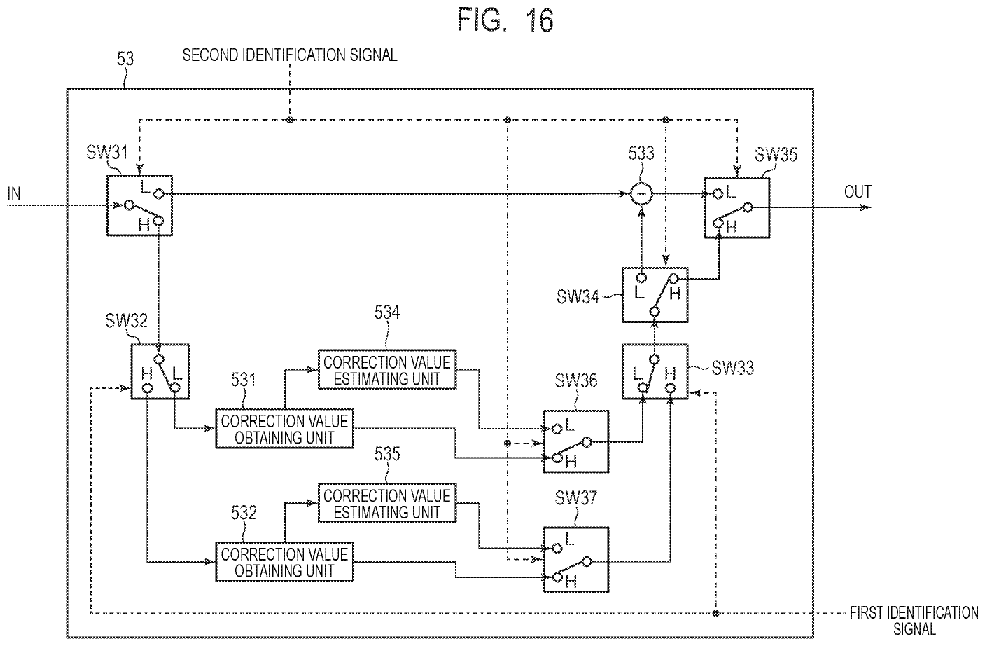

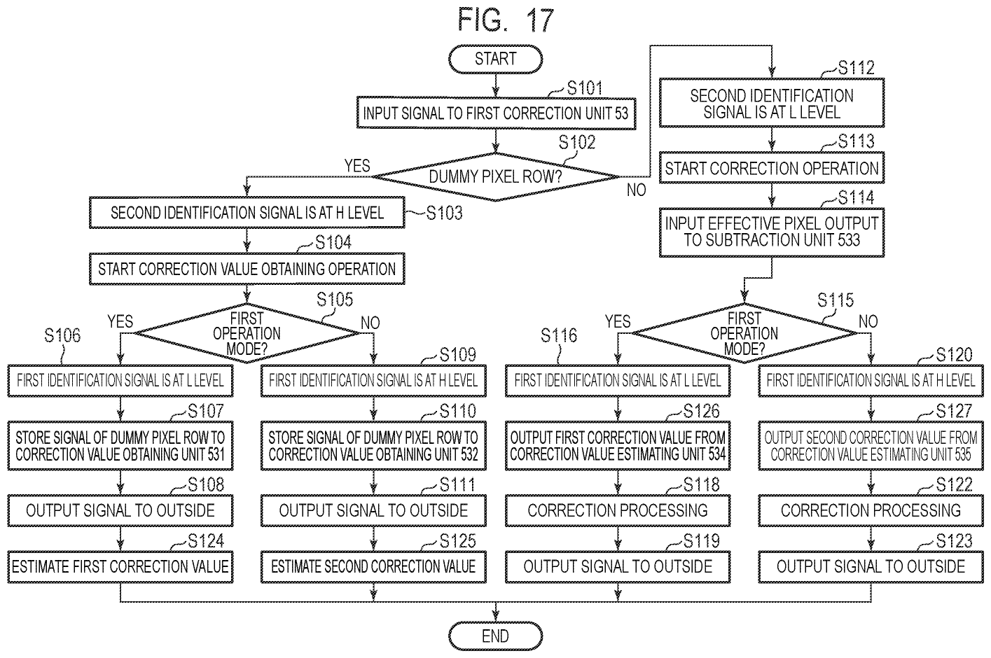

The first correction unit 53 according to the present embodiment will be described with reference to FIGS. 16 and 17. The first correction unit 53 of the present embodiment performs correction processing of reducing a horizontal dark shading shape difference of the black level by the correction value estimated using a signal from the dummy pixel in the dummy pixel row.

FIG. 16 is a block diagram of the first correction unit 53 of the photoelectric conversion device according to the present embodiment. The first correction unit 53 includes correction value obtaining units 531 and 532, a subtraction unit 533, correction value estimating units 534 and 535, and switches SW31, SW32, SW33, SW34, SW35, SW36, and SW37. The switches SW32 and SW33 are switched based on the level of the first identification signal similar to that of the first embodiment. The switches SW31, SW34, SW35, SW36, and SW37 are switched based on the level of the second identification signal similar to that of the first embodiment. That is, in the present embodiment, the correction value estimating units 534 and 535 and the switches SW36 and SW37 are added to the configuration of the first embodiment.

As in the first embodiment, the correction value obtaining unit 531 holds signal read from the pixel of the dummy pixel row in the first operation mode and the correction value obtaining unit 532 holds signal read from the pixel of the dummy pixel row in the second operation mode. The correction value estimating unit 534 receives the output values of the dummy pixel areas 13a, 13b, and 13c in the dummy pixel row and the column address value in the row of the dummy pixel areas 13a, 13b, and 13c from the correction value obtaining unit 531, and the correction value estimating unit 535 receives the output values of the dummy pixel areas 13a, 13b, and 13c in the dummy pixel row and the column address value in the row of the dummy pixel areas 13a, 13b, and 13c from the correction value obtaining unit 532. Each of the correction value estimating units 534 and 535 estimates, based on the output information in the dummy pixel areas 13a, 13b, and 13c, an output value when it is assumed that dummy pixels are present in all columns in the dummy pixel row by calculation, and holds the output value as the correction value. Thus, it is possible to estimate the correction value of the column in which the dummy pixels are not arranged in the dummy pixel row. As an example of the calculation method, there is a method in which a value corresponding to a pixel between the dummy pixel areas 13a, 13b, and 13c arranged intermittently is calculated by polynomial approximation using information of the dummy pixel areas 13a, 13b, and 13c.

An example of a calculation method using quadratic approximation will be described as an example of polynomial approximation. An average output value of the dummy pixel area 13a is A, and the average value of the address value in the column direction is B. The average output value of the dummy pixel area 13b is C, and the average value of the address value in the column direction is D. The average output value of the dummy pixel area 13c is defined as E, and the average value of the address values in the column direction is defined as F. At this time, a quadratic equation for estimating the horizontal dark shading shape of the entire dummy pixel row is calculated by solving three variable simultaneous equations including the following equations (1), (2), and (3) to obtain P, Q, and R.

$$A = {B}^{2} \cdot P + B \cdot Q + R \qquad ( 1 )$$

$$C = {D}^{2} \cdot P + D \cdot Q + R \qquad ( 2 )$$

$$E = {F}^{2} \cdot P + F \cdot Q + R \qquad ( 3 )$$

A quadratic equation indicating the horizontal dark shading shape calculated from the equations (1), (2), and (3) is the following equation (4).

$$Y = P \cdot {X}^{2} + Q \cdot X + R \qquad ( 4 )$$

X is a column address, Y is a correction value for each column address, and P, Q, and R are coefficients calculated from the simultaneous equations.

The switch SW36 outputs an output signal from the correction value obtaining unit 531 to the switch SW33 when the second identification signal is at the H level, and outputs an output signal from the correction value estimating unit 534 to the switch SW33 when the second identification signal is at the L level.

The switch SW37 outputs an output signal from the correction value obtaining unit 532 to the switch SW33 when the second identification signal is at the H level, and outputs an output signal from the correction value estimating unit 535 to the switch SW33 when the second identification signal is at the L level.

The subtraction unit 533 subtracts the signal output from the switch SW34 from the signal output from the switch SW31 and outputs the subtracted signal to the switch SW35. That is, the subtraction unit 533 performs processing of correcting the pixel signal output from the effective pixel 100 of the effective pixel row by the correction value estimated by the correction value estimating unit 534 or 535.

A correction processing procedure of the first correction unit 53 according to the present embodiment will be described with reference to FIG. 17. FIG. 17 is a processing flowchart of the first correction unit 53 according to the present embodiment. FIG. 17 illustrates processing from the time when a signal read from one pixel row is input to the first correction unit 53 to the time when a signal is output. In FIG. 17, steps common to those in the flowchart of FIG. 13 of the first embodiment are denoted by the same reference numerals, and description thereof may be omitted or simplified.

As in the first embodiment, in the present embodiment, when a signal is input to the first correction unit 53, the correction value obtaining operation (step S104) is performed when the second identification signal is at the H level, and the correction operation (step S113) is performed when the second identification signal is at the L level. When the second identification signal is at the H level, the switches SW31, SW34, SW35, SW36, and SW37 are switched to the terminals denoted by “H” illustrated in FIG. 16. Hereinafter, the correction value obtaining operation started from step S104 and the correction operation started from step S113 will be described in order. The correction value obtaining operation started from step S104 will be described.

When the signal of the dummy pixel row input to the first correction unit 53 is read in the first operation mode (YES in step S105), the first identification signal output from the timing generation circuit 33 is at the L level (step S106). In this case, the switch SW32 is switched to a terminal denoted by “L” illustrated in FIG. 16. The signal of the dummy pixel row read in the first operation mode is input to the correction value obtaining unit 531 via the switches SW31 and SW32.

The correction value obtaining unit 531 stores the input signal of the dummy pixel row in the line memory for each pixel (step S107). The signal held in the line memory is used for calculation in the correction value estimating unit 534. The correction value obtaining unit 531 may include an addition averaging unit. When there are a plurality of dummy pixel rows read in the first operation mode, the averaging unit may perform averaging processing of signals of a plurality of rows.

The input signal of the dummy pixel row is held in the correction value obtaining unit 531, and is output to the outside of the first correction unit 53 via the switches SW36, SW33, SW34, and SW35 in this order (step S108).

The correction value estimating unit 534 obtains the output information in the dummy pixel areas 13a, 13b, and 13c from the correction value obtaining unit 531, and estimates a horizontal dark shading shape when it is assumed that the entire dummy pixel row is a dummy pixel (step S124). The specific calculation processing that can be used for this estimation may be, for example, the polynomial approximation described above. The estimated horizontal dark shading shape is used as the first correction value.

On the other hand, when the signal of the dummy pixel row is read in the second operation mode (NO in step S105), the first identification signal output from the timing generation circuit 33 is at the H level (step S109). In this case, the switch SW32 is switched to a terminal denoted by “H” illustrated in FIG. 16. The signal of the dummy pixel row read in the second operation mode is input to the correction value obtaining unit 532 via the switches SW31 and SW32.

Similarly to the correction value obtaining unit 531, the correction value obtaining unit 532 stores the input signal of the dummy pixel row in the line memory for each pixel (step S110). The signal held in the line memory is used for calculation in the correction value estimating unit 535. The input signal of the dummy pixel row is held in the correction value obtaining unit 532, and is output to the outside of the first correction unit 53 via the switches SW37, SW33, SW34, and SW35 in this order (step S111).

The correction value estimating unit 535 obtains the output information in the dummy pixel areas 13a, 13b, and 13c from the correction value obtaining unit 532, and to estimate the horizontal dark shading shape when it is assumed that the entire dummy pixel row is the dummy pixel (step S125). The specific calculation processing that can be used for this estimation may be, for example, the polynomial approximation described above. The estimated horizontal dark shading shape is used as a second correction value.

Thus, according to the operation mode at the time of reading out the dummy pixel row, the correction value obtaining units 531 and 532 obtain the output signals from the dummy pixel row, and the correction value estimating units 534 and 535 estimate the first correction value and the second correction value. These correction values are used when a signal read from an effective pixel row is corrected for each pixel.

The correction operation started from step S113 will be described. It is assumed that the first correction value and the second correction value have already been held in the correction value estimating units 534 and 535 by the above-described processing.

A signal input at the time of the correction operation is a signal from other than the dummy pixel row. In the following description, it is assumed that the input signal is a signal output from the effective pixel row. The correction processing is performed on the image signal A+B. The signal of the effective pixel row is input to the subtraction unit 533 via the switch SW31 (step S114).

The subtraction unit 533 performs processing for correcting the horizontal dark shading shape by subtracting one of the first correction value and the second correction value from the signal output from the effective pixel row. A method of switching the correction value will be described.

The signal of the effective pixel row input to the first correction unit 53 is read from the pixel array 10 in the first operation mode or the second operation mode. When the signal of the effective pixel row is read in the first operation mode (YES in step S115), the first identification signal output from the timing generation circuit 33 is at the L level (step S116). In this case, the switch SW33 is switched to a terminal denoted by “L” illustrated in FIG. 16. Since the second identification signal is at the L level, the switches SW36 and SW34 are switched to the terminals denoted by “L” illustrated in FIG. 16. Thereby, the first correction value held in the correction value estimating unit 534 is output to the subtraction unit 533 via the switches SW36, SW33, and SW34 (step S126). The subtraction unit 533 corrects the horizontal dark shading shape by subtracting the first correction value from the signal of the effective pixel row (step S118). The signal corrected by the subtraction unit 533 is output to the outside of the first correction unit 53 via the switch SW35 (step S119).

On the other hand, when the signal of the effective pixel row is read in the second operation mode (NO in step S115), the first identification signal output from the timing generation circuit 33 is at the H level (step S120). In this case, the switch SW33 is switched to the terminal denoted by “H” illustrated in FIG. 16. When the second identification signal is at the L level, the switches SW36 and SW34 are switched to the terminals denoted by “L” illustrated in FIG. 16. Thereby, the second correction value held in the correction value estimating unit 535 is output to the subtraction unit 533 via the switches SW37, SW33, and SW34 (step S127). The subtraction unit 533 corrects the horizontal dark shading shape by subtracting the second correction value from the signal of the effective pixel row (step S122). The signal corrected by the subtraction unit 533 is output to the outside of the first correction unit 53 via the switch SW35 (step S123).

In this way, the subtraction unit 533 performs correction using the correction value that varies depending on the operation mode when the signal from the effective pixel row is read. This makes it possible to appropriately correct the difference between the horizontal dark shading shapes.

As described above, according to the present embodiment, it is possible to provide the photoelectric conversion device capable of appropriately correcting horizontal dark shading as in the first embodiment even when the dummy pixel areas are arranged intermittently in the same row. Since the range of the OB pixel area 12 can be enlarged, the accuracy of the OB clamp processing can be improved.

In the present embodiment, the number of dummy pixel areas arranged intermittently in the same row is three, but the number of pixel areas is not limited thereto. Even in the configuration in which the dummy pixel area is not intermittent as in the first embodiment, the correction value estimating processing of the present embodiment may be applied by dividing the area used for the calculation in the dummy pixel area into several areas. Although an example in which the order of the polynomial used in the estimation in the estimation of the correction value is the second order is illustrated, the order may be appropriately changed. A value obtained by a calculation inside the photoelectric conversion device may be applied to the coefficient of the polynomial, or the coefficient may be set by providing a register for holding the coefficient inside the photoelectric conversion device and by inputting the coefficient from the outside.

In the present embodiment, the output signal from the dummy pixel row is used for calculating the correction value in the first correction unit 53, but the output signal from the OB pixel row may be used for similar correction processing. For example, in an environment in which the dark current component is sufficiently small, such as in a low temperature environment, the output signal from the OB pixel row can be substituted for the output signal from the dummy pixel row. In this case, instead of the dummy pixel areas 13a, 13b, and 13c illustrated in FIG. 15, the plurality of OB pixel areas may be intermittently arranged in the same row. The correction value estimation processing of the present embodiment may be similarly applied to output signals from a plurality of OB pixel areas arranged intermittently in the same row. This provides the photoelectric conversion device capable of appropriately correcting horizontal dark shading as in the first embodiment even when the OB pixel areas are arranged intermittently in the same row.

### Third Embodiment

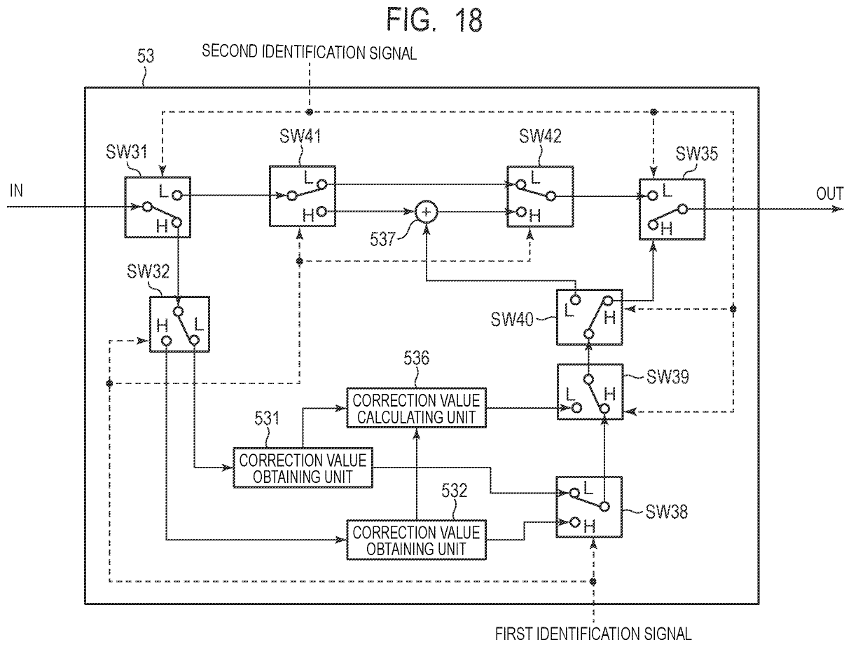

A photoelectric conversion device according to a third embodiment will be described with reference to FIGS. 18 to 20C. In the present embodiment, a correction method in which a focus detection line is corrected and a normal line is not corrected will be described. In this method, although the horizontal dark shading shape is not reduced, it is possible to reduce the difference in the horizontal dark shading shape due to the difference in the operation mode of reading. The configuration of the present embodiment is suitable for a case where the signal processing circuit for correcting the horizontal dark shading shape of the entire image so as to be uniform is arranged in a rear stage of the photoelectric conversion device. The description of elements common to those of the first embodiment may be omitted or simplified as appropriate.

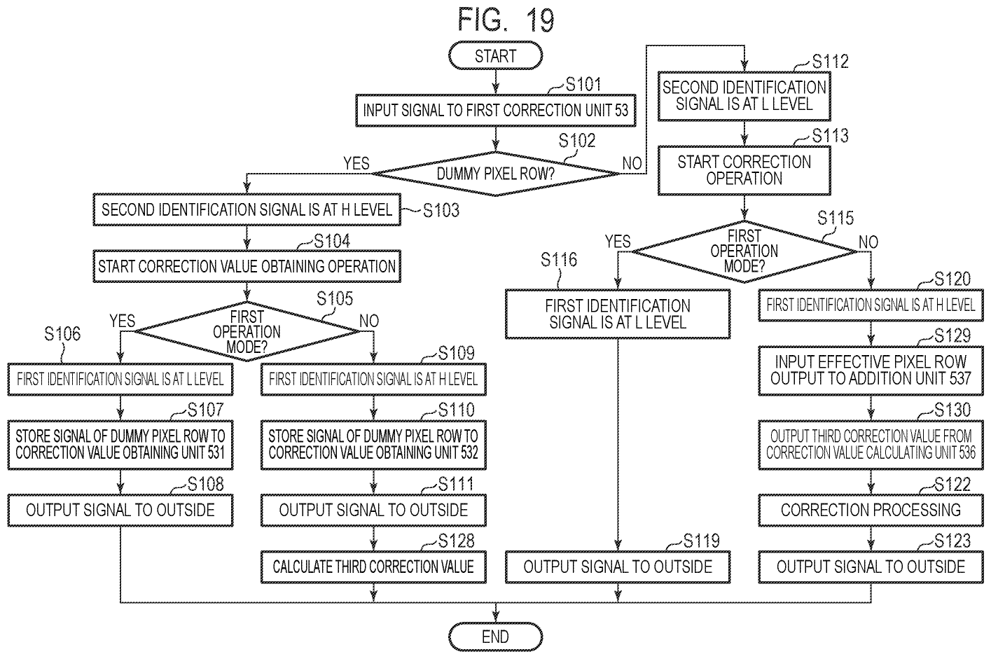

The first correction unit 53 according to the present embodiment will be described with reference to FIGS. 18 and 19. The first correction unit 53 of the present embodiment performs correction processing for making the shapes of the horizontal dark shadings close to each other in the two operation modes.

FIG. 18 is a block diagram of a first correction unit 53 of the photoelectric conversion device according to the present embodiment. The first correction unit 53 includes correction value obtaining units 531 and 532, a correction value calculating unit 536, an addition unit 537, and switches SW31, SW32, SW35, SW38, SW39, SW40, SW41, and SW42. The switches SW32, SW38, SW41, and SW42 are switched based on the level of the first identification signal similar to that of the first embodiment. The switches SW31, SW35, SW39, and SW40 are switched based on the level of the second identification signal similar to that of the first embodiment.

As in the first embodiment, the correction value obtaining unit 531 holds signal read from the pixel of the dummy pixel row in the first operation mode and the correction value obtaining unit 532 holds signal read from the pixel of the dummy pixel row in the second operation mode. The correction value calculating unit 536 calculates a difference between the signal of the dummy pixel row input to the correction value obtaining unit 531 and the signal of the dummy pixel row input to the correction value obtaining unit 532. Thus, the correction value calculating unit 536 calculates a relative shift amount of the horizontal dark shading in the two operation modes, and holds the calculated relative shift amount as a third correction value.

The switch SW38 outputs an output signal from the correction value obtaining unit 531 to the switch SW39 when the first identification signal is at the L level, and outputs an output signal from the correction value obtaining unit 532 to the switch SW39 when the first identification signal is at the H level.

The switch SW39 outputs an output signal from the correction value calculating unit 536 to the switch SW40 when the second identification signal is at the L level, and outputs an output signal from the switch SW38 to the switch SW40 when the second identification signal is at the H level.

The switch SW40 outputs an output signal from the switch SW39 to the addition unit 537 when the second identification signal is at the L level, and outputs an output signal from the switch SW39 to the switch SW35 when the second identification signal is at the H level.

The switch SW31 outputs a signal to the switch SW41 when the second identification signal is at the L level, and outputs a signal to the switch SW32 when the second identification signal is at the H level. The switch SW41 outputs a signal to the switch SW42 when the first identification signal is at the L level, and outputs a signal to the addition unit 537 when the first identification signal is at the H level.

The addition unit 537 adds the signal output from the switch SW41 and the signal output from the switch SW40, and outputs the sum to the switch SW42. That is, the addition unit 537 performs processing of correcting the pixel signal output from the effective pixel row with the third correction value held in the correction value calculating unit 536.

The switch SW42 outputs an output signal from the switch SW41 to the switch SW35 when the first identification signal is at the L level, and outputs an output signal from the addition unit 537 to the switch SW35 when the first identification signal is at the H level. That is, when the first identification signal is at the H level, the correction processing in the addition unit 537 is performed, whereas when the first identification signal is at the L level, the correction processing in the addition unit 537 is not performed.

A correction processing procedure of the first correction unit 53 according to the present embodiment will be described with reference to FIG. 19. FIG. 19 is a processing flowchart of the first correction unit 53 according to the present embodiment. FIG. 19 illustrates processing from the time when a signal read from one pixel row is input to the first correction unit 53 to the time when a signal is output. In FIG. 19, steps common to those in the flowchart of FIG. 13 of the first embodiment are denoted by the same reference numerals, and description thereof may be omitted or simplified.

As in the first embodiment, in the present embodiment, when a signal is input to the first correction unit 53, the correction value obtaining operation (step S104) is performed when the second identification signal is at the H level, and the correction operation (step S113) is performed when the second identification signal is at the L level. When the second identification signal is at the H level, the switches SW31, SW35, SW39, and SW40 are switched to the terminals denoted by “H” illustrated in FIG. 18. Hereinafter, the correction value obtaining operation started from step S104 and the correction operation started from step S113 will be described in order. The correction value obtaining operation started from step S104 will be described.

When the signal of the dummy pixel row input to the first correction unit 53 is read in the first operation mode (YES in step S105), the first identification signal output from the timing generation circuit 33 is at the L level (step S106). In this case, the switch SW32 is switched to a terminal denoted by “L” illustrated in FIG. 18. The signal of the dummy pixel row read in the first operation mode is input to the correction value obtaining unit 531 via the switches SW31 and SW32.

The correction value obtaining unit 531 stores the input signal of the dummy pixel row in the line memory for each pixel (step S107). The signal held in the line memory is used for calculation in the correction value calculating unit 536. The correction value obtaining unit 531 may include an addition averaging unit. When there are a plurality of dummy pixel rows read in the first operation mode, the averaging unit may perform averaging processing of signals of a plurality of rows.

The input signal of the dummy pixel row is held in the correction value obtaining unit 531, and is output to the outside of the first correction unit 53 via the switches SW38, SW39, SW40, and SW35 in this order (step S108).

On the other hand, when the signal of the dummy pixel row is read in the second operation mode (NO in step S105), the first identification signal output from the timing generation circuit 33 is at the H level (step S109). In this case, the switch SW32 is switched to a terminal denoted by “H” illustrated in FIG. 18. The signal of the dummy pixel row read in the second operation mode is input to the correction value obtaining unit 532 via the switches SW31 and SW32.

Similarly to the correction value obtaining unit 531, the correction value obtaining unit 532 stores the input signal of the dummy pixel row in the line memory for each pixel (step S110). The signal held in the line memory is used for calculation in the correction value calculating unit 536. The input signal of the dummy pixel row is held in the correction value obtaining unit 532, and is output to the outside of the first correction unit 53 via the switches SW38, SW39, SW40, and SW35 in this order (step S111).

The correction value calculating unit 536 calculates a difference between the dummy row signals held in the correction value obtaining units 531 and 532, and calculates a relative shift amount of the horizontal dark shading in the two operation modes as a third correction value (step S128). The third correction value is used for correcting, for each pixel, a signal read from the focus detection row of the effective pixel row.

The correction operation started from step S113 will be described. It is assumed that the above-described third correction value is already held in the correction value calculating unit 536 by the above-described processing.

A signal input at the time of the correction operation is a signal from other than the dummy pixel row. In the following description, it is assumed that the input signal is a signal output from the effective pixel row. The correction processing is performed on the image signal A+B. The signal of the effective pixel row is input to the switch SW31.

The signal of the effective pixel row input to the first correction unit 53 is read from the pixel array 10 in the first operation mode or the second operation mode. When the signal of the effective pixel row is read in the first operation mode (YES in step S115), the first identification signal output from the timing generation circuit 33 is at the L level (step S116). In this case, the switches SW41 and SW42 are switched to the terminal denoted by “L” illustrated in FIG. 18. Since the second identification signal is at the L level, the switches SW31 and SW35 are switched to the terminals denoted by “L” illustrated in FIG. 18. Thereby, the signal of the effective pixel row input to the first correction unit 53 is output to the outside of the first correction unit 53 via the switches SW31, SW41, SW42, and SW35 without passing through the addition unit 537 (step S119). That is, the horizontal dark shading is not corrected for the signal of the effective pixel row read in the first operation mode.

On the other hand, when the signal of the effective pixel row is read in the second operation mode (NO in step S115), the first identification signal output from the timing generation circuit 33 is at the H level (step S120). In this case, the switches SW41 and SW42 are switched to the terminal denoted by “H” illustrated in FIG. 18. When the second identification signal is at the L level, the switches SW31 and SW35 are switched to the terminals denoted by “L” illustrated in FIG. 18. Thereby, the signal of the effective pixel row input to the first correction unit 53 is input to the addition unit 537 via the switches SW31 and SW41 (step S129).

When the second identification signal is at the L level, the switches SW39 and SW40 are switched to the terminals denoted by “L” illustrated in FIG. 18. Thereby, the third correction value held in the correction value calculating unit 536 is output to the addition unit 537 via the switches SW39 and SW40 (step S130). The addition unit 537 corrects the horizontal dark shading shape by adding the third correction value to the signal of the effective pixel row (step S122). The signal corrected by the addition unit 537 is output to the outside of the first correction unit 53 via the switches SW42 and SW35 (step S123).

As described above, the first correction unit 53 of the present embodiment corrects only the signal read in the second operation mode based on the horizontal dark shading shape of the signal read in the first operation mode. This reduces relative differences in horizontal dark shading shapes.

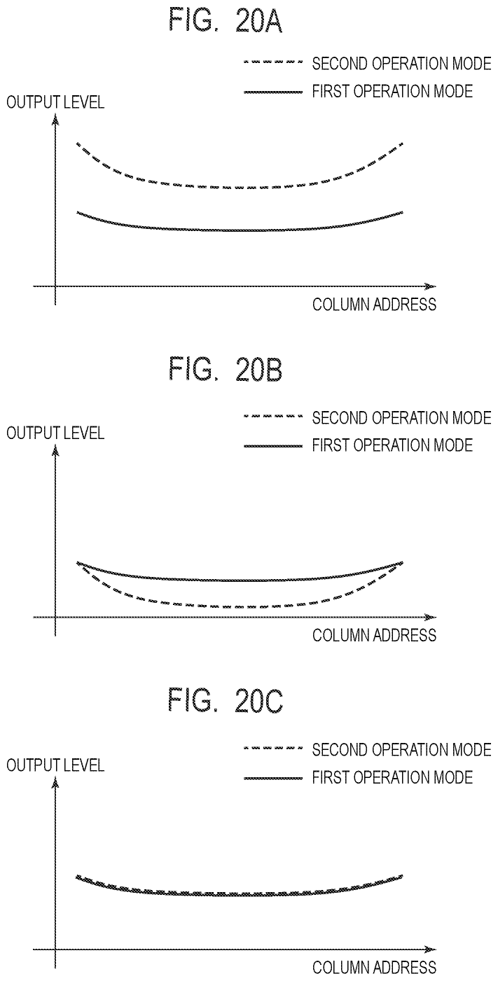

FIGS. 20A, 20B, and 20C are graphs for illustrating the effect of correction in the signal processing circuit 50. Since the vertical axis and the horizontal axis of the graph are the same as those illustrated in FIG. 8B, their description is omitted.

FIG. 20A is a graph for illustrating the shape of the horizontal dark shading before correction. As described above, in the first operation mode and the second operation mode, there is a difference in both the offset and the shape of the horizontal dark shading.

FIG. 20B is a graph for illustrating the shape of horizontal dark shading for each operation mode corrected by the second correction unit 52. The offset component difference is reduced by subtracting the correction value corresponding to the dark current component calculated by the averaging units 522 and 523 of the second correction unit 52.

FIG. 20C is a graph for illustrating the shape of the horizontal dark shading for each operation mode corrected by the first correction unit 53. The shape of the horizontal dark shading in the first operation mode is not corrected. However, the shape of the horizontal dark shading in the second operation mode is corrected so as to be close to the shape of the horizontal dark shading in the first operation mode. Thereby, it is possible to reduce a signal level difference in an image that may occur at the boundary between the normal line and the focus detection line.

As described above, also in the present embodiment, the photoelectric conversion device capable of appropriately correcting the horizontal dark shading is provided.

In the present embodiment, the focus detection line is corrected and the normal line is not corrected, but the correction target may be reversed. That is, the first correction unit 53 may not correct the shape of the horizontal dark shading in the second operation mode, but may correct only the signal read in the first operation mode based on the horizontal dark shading shape of the signal read in the second operation mode. Also in this case, the relative difference between the horizontal dark shading shapes is reduced.

### Fourth Embodiment

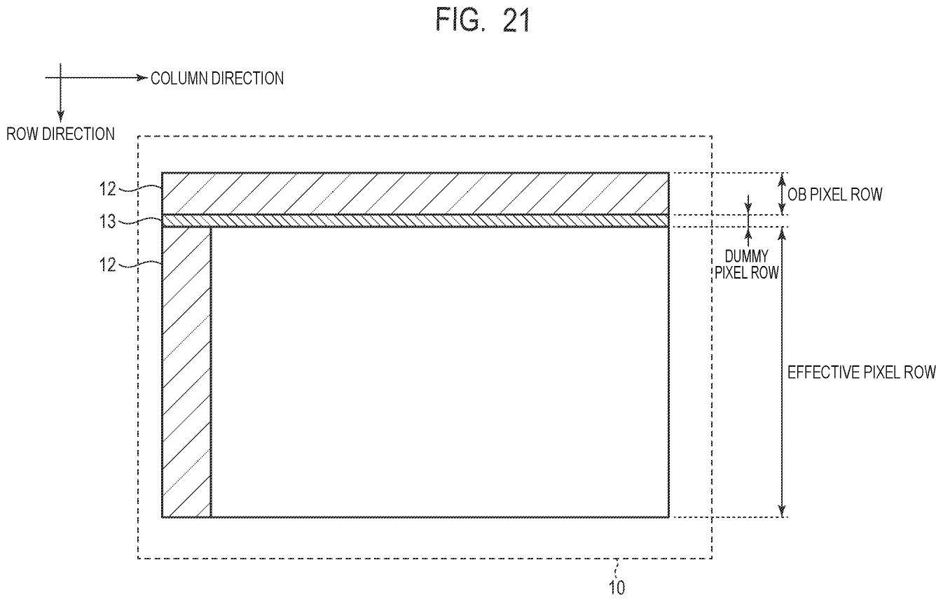

A photoelectric conversion device according to a fourth embodiment will be described with reference to FIG. 21. In the present embodiment, the arrangement of the OB pixel row and the dummy pixel row and the reading order are changed. The description of elements common to those of the first embodiment may be omitted or simplified as appropriate.

FIG. 21 is a diagram for illustrating a layout of the pixel array 10 in the present embodiment. As illustrated in FIG. 21, the dummy pixel row (third pixel row) is disposed between the effective pixel row (first pixel row) and the OB pixel row (fourth pixel row).

It is assumed that the signal reading of each row is performed sequentially from the uppermost row in FIG. 21. That is, in the present embodiment, the dummy pixel row is read after the OB pixel row is read. After the dummy pixel row is read, the effective pixel row is read.

Immediately after the reading of the uppermost row, since the elapsed time from the power on of the circuit of the photoelectric conversion device is short, the state of power supply from the power source may not be sufficiently fixed. This effect may appear in an output signal as variation or fixed pattern noise. In the correction of the horizontal dark shading, it is necessary to obtain a highly accurate correction value for each pixel in the column direction. When the signal of the dummy pixel row used to obtain the correction value is read after the signal of the OB pixel row is read, the accuracy degradation due to the above-described factors is reduced, and the correction accuracy can be improved. Therefore, according to the present embodiment, the accuracy of the correction processing can be further improved.

In the present embodiment, the reading of the dummy pixel row is performed immediately before the reading of the effective pixel row. If the state of power supply is sufficiently settled, the dummy pixel row may not be read immediately before the effective pixel row. For example, the reading of the dummy pixel row may be performed between the reading of a plurality of OB pixel rows. In other words, the reading order may be the order of the OB pixel row, the dummy pixel row, the OB pixel row, and the effective pixel row.

### Fifth Embodiment

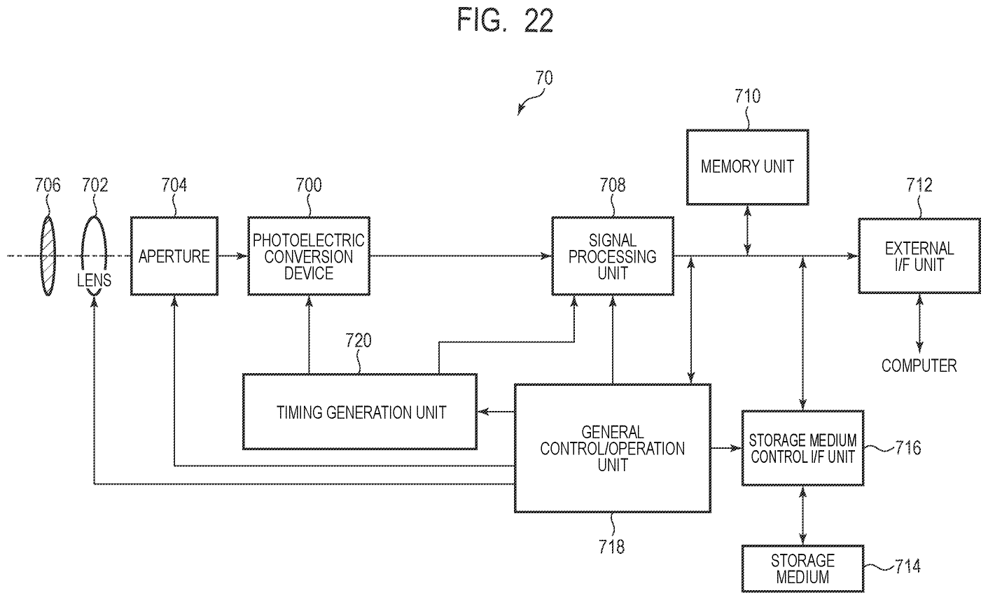

The photoelectric conversion device of the above embodiments can be applied to various equipment. Examples of the equipment include a digital camera, a digital camcorder, a camera head, a copying machine, a facsimile, a mobile phone, a vehicle-mounted camera, an observation satellite, and a surveillance camera. FIG. 22 is a block diagram of a digital camera as an example of equipment.

The equipment 70 illustrated in FIG. 22 includes a barrier 706, a lens 702, an aperture 704, and a photoelectric conversion device 700. The equipment 70 further includes a signal processing unit (processing device) 708, a timing generation unit 720, a general control/operation unit 718 (control device), a memory unit 710 (storage device), a storage medium control I/F unit 716, a storage medium 714, and an external I/F unit 712. At least one of the barrier 706, the lens 702, and the aperture 704 is an optical device corresponding to the equipment. The barrier 706 protects the lens 702, and the lens 702 forms an optical image of an object on the photoelectric conversion device 700. The aperture 704 varies the amount of light passing through the lens 702. The photoelectric conversion device 700 is configured as in the above embodiments, and converts an optical image formed by the lens 702 into image data (image signal). The signal processing unit 708 performs various corrections, data compression, and the like on the image data output from the photoelectric conversion device 700. The timing generation unit 720 outputs various timing signals to the photoelectric conversion device 700 and the signal processing unit 708. The general control/operation unit 718 controls the entire digital camera, and the memory unit 710 temporarily stores image data. The storage medium control I/F unit 716 is an interface for storing or reading image data on the storage medium 714, and the storage medium 714 is a detachable storage medium such as a semiconductor memory for storing or reading captured image data. The external I/F unit 712 is an interface for communicating with an external computer or the like. The timing signal or the like may be input from the outside of the equipment. The equipment 70 may further include a display device (a monitor, an electronic view finder, or the like) for displaying information obtained by the photoelectric conversion device. The equipment includes at least a photoelectric conversion device. Further, the equipment 70 includes at least one of an optical device, a control device, a processing device, a display device, a storage device, and a mechanical device that operates based on information obtained by the photoelectric conversion device. The mechanical device is a movable portion (for example, a robot arm) that receives a signal from the photoelectric conversion device for operation.

Each pixel circuit may include a plurality of photoelectric conversion units (a first photoelectric conversion unit and a second photoelectric conversion unit). The signal processing unit 708 may be configured to process a pixel signal based on charges generated in the first photoelectric conversion unit and a pixel signal based on charges generated in the second photoelectric conversion unit, and acquire distance information from the photoelectric conversion device 700 to an object.

### Sixth Embodiment

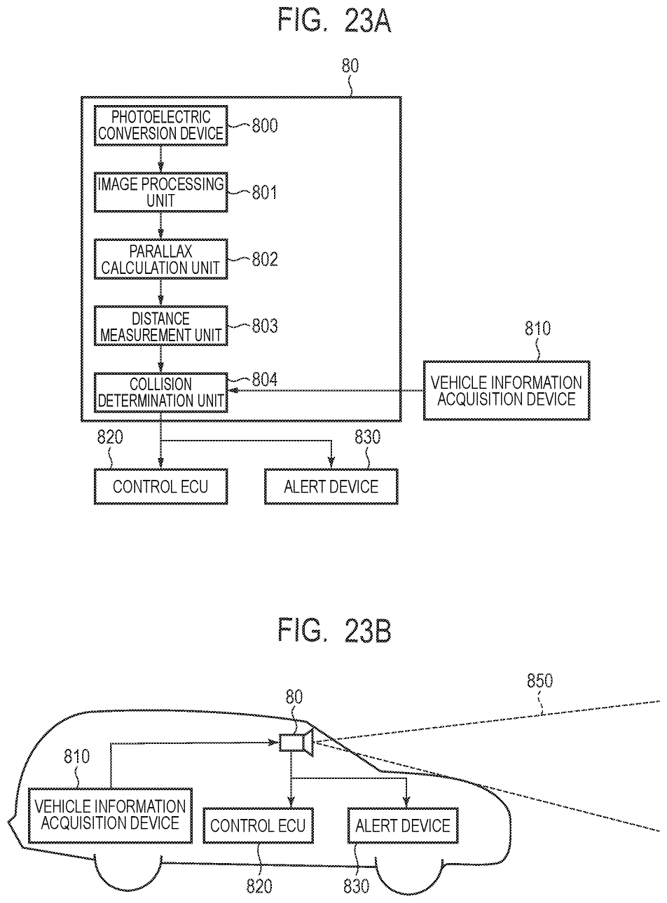

FIGS. 23A and 23B are block diagrams of equipment relating to the vehicle-mounted camera according to the present embodiment. The equipment 80 includes a photoelectric conversion device 800 of the above-described embodiments and a signal processing device (processing device) that processes a signal from the photoelectric conversion device 800. The equipment 80 includes an image processing unit 801 that performs image processing on a plurality of pieces of image data acquired by the photoelectric conversion device 800, and a parallax calculation unit 802 that calculates parallax (phase difference of parallax images) from the plurality of pieces of image data acquired by the equipment 80. The equipment 80 includes a distance measurement unit 803 that calculates a distance to an object based on the calculated parallax, and a collision determination unit 804 that determines whether or not there is a possibility of collision based on the calculated distance. Here, the parallax calculation unit 802 and the distance measurement unit 803 are examples of a distance information acquisition unit that acquires distance information to the object. That is, the distance information is information on a parallax, a defocus amount, a distance to the object, and the like. The collision determination unit 804 may determine the possibility of collision using any of these pieces of distance information. The distance information acquisition unit may be realized by dedicatedly designed hardware or software modules. Further, it may be realized by a field programmable gate array (FPGA), an application specific integrated circuit (ASIC) or a combination thereof.

The equipment 80 is connected to the vehicle information acquisition device 810, and can obtain vehicle information such as a vehicle speed, a yaw rate, and a steering angle. Further, the equipment 80 is connected to a control ECU 820 which is a control device that outputs a control signal for generating a braking force to the vehicle based on the determination result of the collision determination unit 804. The equipment 80 is also connected to an alert device 830 that issues an alert to the driver based on the determination result of the collision determination unit 804. For example, when the collision possibility is high as the determination result of the collision determination unit 804, the control ECU 820 performs vehicle control to avoid collision or reduce damage by braking, returning an accelerator, suppressing engine output, or the like. The alert device 830 alerts the user by sounding an alarm such as a sound, displaying alert information on a screen of a car navigation system or the like, or giving vibration to a seat belt or a steering wheel. The equipment 80 functions as a control unit that controls the operation of controlling the vehicle as described above.

In the present embodiment, an image of the periphery of the vehicle, for example, the front or the rear is captured by the equipment 80. FIG. 23B illustrates equipment in a case where an image is captured in front of the vehicle (image capturing range 850). The vehicle information acquisition device 810 as the imaging control unit sends an instruction to the equipment 80 or the photoelectric conversion device 800 to perform the imaging operation. With such a configuration, the accuracy of distance measurement can be further improved.

Although the example of control for avoiding a collision to another vehicle has been described above, the embodiment is applicable to automatic driving control for following another vehicle, automatic driving control for not going out of a traffic lane, or the like. Furthermore, the equipment is not limited to a vehicle such as an automobile and can be applied to a movable body (movable apparatus) such as a ship, an airplane, a satellite, an industrial robot and a consumer use robot, or the like, for example. In addition, the equipment can be widely applied to equipment which utilizes object recognition or biometric authentication, such as an intelligent transportation system (ITS), a surveillance system, or the like without being limited to movable bodies.

### Modified Embodiments

The present invention is not limited to the above embodiments, and various modifications are possible. For example, an example in which some of the configurations of any one of the embodiments are added to other embodiments or an example in which some of the configurations of any one of the embodiments are replaced with some of the configurations of other embodiments are also embodiments of the present invention.

The disclosure of this specification includes a complementary set of the concepts described in this specification. That is, for example, if a description of “A is B” (A=B) is provided in this specification, this specification is intended to disclose or suggest that “A is not B” even if a description of “A is not B” (A+B) is omitted. This is because it is assumed that “A is not B” is considered when “A is B” is described.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-023094, filed Feb. 17, 2023, which is hereby incorporated by reference herein in its entirety.

What is claimed is:

1. A photoelectric conversion device comprising:
a pixel array in which a plurality of pixels are arranged in a plurality of rows and a plurality of columns, the pixel array including a first pixel row including a first pixel having a plurality of photoelectric conversion units each configured to generate charges based on incident light and a second pixel row including a non-photosensitive pixel configured to output a signal not based on the incident light;
a reading unit configured to read a signal from the first pixel and the non-photosensitive pixel; and
a first correction unit configured to correct a signal read from the first pixel,
wherein the number of the non-photosensitive pixels arranged in the second pixel row is greater than the number of the first pixels arranged in the second pixel row,
wherein reading of a signal from the pixel array to the reading unit includes a first driving for outputting a signal based on a sum of charges generated in each of the plurality of photoelectric conversion units and a second driving for outputting a signal based on charges generated in one of the plurality of photoelectric conversion units,
wherein a first operation mode in which a signal is read from a pixel of one row by the first driving and a second operation mode in which a signal is read from a pixel of one row by continuously performing the first driving and the second driving are switchable for each row, and
wherein the first correction unit generates a first correction value based on an output signal of the second pixel row read in the first operation mode, generates a second correction value based on an output signal of the second pixel row read in the second operation mode, and corrects an output signal of the first pixel row based on the first correction value and the second correction value.

2. The photoelectric conversion device according to claim 1, wherein the second pixel row includes a second pixel having no photoelectric conversion unit.

3. The photoelectric conversion device according to claim 1, wherein the second pixel row includes a third pixel having a plurality of light shielded photoelectric conversion units.

4. The photoelectric conversion device according to claim 1, wherein the first correction unit corrects an output signal of the first pixel row read in the first operation mode with the first correction value, and corrects an output signal of the first pixel row read in the second operation mode with the second correction value.

5. The photoelectric conversion device according to claim 1,
wherein the second pixel row includes a second pixel having no photoelectric conversion unit,
wherein a plurality of the second pixels are intermittently arranged in one row, and
wherein the first correction unit generates the first correction value and the second correction value based on output signals of the plurality of second pixels.

6. The photoelectric conversion device according to claim 5, wherein the first correction unit, in generating the first correction value and the second correction value, performs a process of estimating the first correction value and the second correction value of a column in which the second pixel is not arranged based on output signals of the plurality of second pixels.

7. The photoelectric conversion device according to claim 5, wherein the first correction unit, in generating the first correction value and the second correction value, performs a process of estimating the first correction value and the second correction value of a column in which the second pixel is not arranged by approximating output signals of the plurality of second pixels using a polynomial.

8. The photoelectric conversion device according to claim 1,
wherein the second pixel row includes a third pixel having a plurality of light shielded photoelectric conversion units,
wherein a plurality of the third pixels are intermittently arranged in one row, and
wherein the first correction unit generates the first correction value and the second correction value based on signals of the plurality of third pixels.

9. The photoelectric conversion device according to claim 8, wherein the first correction unit, in generating the first correction value and the second correction value, performs a process of estimating the first correction value and the second correction value of a column in which the third pixel is not arranged based on output signals of the plurality of third pixels.

10. The photoelectric conversion device according to claim 8, wherein the first correction unit, in generating the first correction value and the second correction value, performs a process of estimating the first correction value and the second correction value of a column in which the third pixel is not arranged by approximating output signals of the plurality of third pixels using a polynomial.

11. The photoelectric conversion device according to claim 1, wherein the first correction unit generates a third correction value based on the first correction value and the second correction value, and corrects an output signal of the first pixel row based on the third correction value.

12. The photoelectric conversion device according to claim 11, wherein the first correction unit corrects only one of an output signal read from the first pixel row in the first operation mode and an output signal read from the first pixel row in the second operation mode based on the third correction value.

13. The photoelectric conversion device according to claim 1,
wherein the second pixel row includes a plurality of rows including a third pixel row including a second pixel having no photoelectric conversion unit and a fourth pixel row including a third pixel having a plurality of light shielded photoelectric conversion units, and
wherein in reading signals from the pixel array to the reading unit, reading of the third pixel row is performed between reading of the fourth pixel row and reading of the first pixel row.

14. The photoelectric conversion device according to claim 1, wherein the first pixel row further includes a third pixel having a plurality of light shielded photoelectric conversion units.

15. The photoelectric conversion device according to claim 14 further comprising a second correction unit configured to generate a fourth correction value based on an output signal of the third pixel in the first pixel row read in the first operation mode, generate a fifth correction value based on an output signal of the third pixel in the first pixel row read in the second operation mode, and correct an output signal of the first pixel row based on the fourth correction value and the fifth correction value.

16. The photoelectric conversion device according to claim 15, wherein the second correction unit corrects an output signal of the first pixel row read in the first operation mode with the fourth correction value, and corrects an output signal of the first pixel row read in the second operation mode with the fifth correction value.

17. The photoelectric conversion device according to claim 1 further comprising a microlens,
wherein the incident light having passed through one microlens is incident on the plurality of photoelectric conversion units.

18. The photoelectric conversion device according to claim 1, wherein in the second operation mode, the first driving is performed after the second driving.

19. The photoelectric conversion device according to claim 1,
wherein in the first pixel row, the first pixel is arranged from a first column closest to one end of the photoelectric conversion device to a second column closest to another end opposite to the one end, and
wherein in the second pixel row, the second pixel is arranged from the first column to the second column.

20. Equipment comprising:
the photoelectric conversion device according to claim 1; and
at least any one of:
an optical device adapted for the photoelectric conversion device,
a control device configured to control the photoelectric conversion device,
a processing device configured to process a signal output from the photoelectric conversion device,
a display device configured to display information obtained by the photoelectric conversion device,
a storage device configured to store information obtained by the photoelectric conversion device, and
a mechanical device configured to operate based on information obtained by the photoelectric conversion device.

21. The equipment according to claim 20, wherein the processing device processes image signals that are generated by a plurality of photoelectric conversion units, respectively, and acquires distance information on a distance from the photoelectric conversion device to an object.
